(19) United States
(12) Patent Application Publication
(10) Pub. No.: US 2024/0010803 A1
(43) Pub. Date: Jan. 11, 2024

(54) POLYAMIDE-BASED FILM, METHOD OF PREPARING THE SAME, AND COVER WINDOW AND DISPLAY DEVICE COMPRISING THE SAME

(71) Applicant: SK microworks Co., Ltd., Gyeonggi-do (KR)

(72) Inventors: Hak Soo LEE, Gyeonggi-do (KR); Sang Hun CHOI, Gyeonggi-do (KR); Jin Woo LEE, Gyeonggi-do (KR)

(21) Appl. No.: 18/337,037

(22) Filed: Jun. 19, 2023

(30) Foreign Application Priority Data
Jul. 8, 2022 (KR) 10-2022-0084551

(51) Int. Cl. C08J 5/18; C08G 69/42; C08K 7/18

(52) U.S. Cl. CPC C08J 5/18; C08G 69/42; C08K 7/18; C08J 2377/10; C08G 2220/00; C08K 2201/003; C08K 2201/011

(57) ABSTRACT

The embodiments relate to a polyamide-based film that is excellent in solvent resistance and optical properties, to a process for preparing the same, and to a cover window and a display device comprising the same. The polyamide-based film comprises a polyamide-based polymer, wherein when the 3D surface roughness of a first side of the film is measured, the volume (natural volume) between the surface and a reference plane placed at the elevation of the highest peak parallel to the surface plane is 100 μm³ to 2,800 μm³.

### CROSS-REFERENCE TO RELATED APPLICATIONS

The present application claims priority of Korean Patent Application No. 10-2022-0084551, filed on Jul. 8, 2022, which is incorporated herein by reference in its entirety.

### TECHNICAL FIELD

Embodiments relate to a polyamide-based film, to a process for preparing the same, and to a cover window and a display device comprising the same.

### BACKGROUND ART

Polyamide-based resins such as poly(amide-imide) (PAI) are excellent in resistance to friction, heat, and chemicals. Thus, they are employed in such applications as primary electrical insulation, coatings, adhesives, resins for extrusion, heat-resistant paintings, heat-resistant boards, heat-resistant adhesives, heat-resistant fibers, and heat-resistant films.

Polyamide is used in various fields. For example, polyamide is made in the form of a powder and used as a coating for a metal or a magnetic wire. It is mixed with other additives depending on the application thereof. In addition, polyamide is used together with a fluoropolymer as a painter for decoration and corrosion prevention. It also plays a role of bonding a fluoropolymer to a metal substrate. In addition, polyamide is used to coat kitchenware, used as a membrane for gas separation by virtue of its heat resistance and chemical resistance, and used in natural gas wells for filtration of such contaminants as carbon dioxide, hydrogen sulfide, and impurities.

In recent years, polyamide has been developed in the form of a film, which is less expensive and has excellent optical, mechanical, and thermal characteristics. Such a polyamide-based film may be applied to display materials for organic light-emitting diodes (OLEDs) or liquid crystal displays (LCDs), and the like, and to antireflection films, compensation films, and retardation films if retardation properties are implemented.

When such a polyamide-based film is applied to a foldable display, a flexible display, and the like, optical properties such as transparency and colorlessness and mechanical properties such as flexibility and hardness are required. In general, however, since optical properties and mechanical properties are in a trade-off relationship, an improvement in the mechanical properties would impair the optical properties.

Accordingly, research on polyamide-based films with improved mechanical properties and optical properties is continuously required.

### DETAILED DESCRIPTION OF THE INVENTION

### Technical Problem

The embodiments provide a polyamide-based film that is excellent in optical properties and mechanical properties and a cover window and a display device comprising the same.

The embodiments provide a process for preparing a polyamide-based film that is excellent in optical properties and mechanical properties.

### Solution to the Problem

The polyamide-based film according to an embodiment comprises a polyamide-based polymer, wherein when the 3D surface roughness of a first side of the film is measured, the volume (natural volume) between the surface and a reference plane placed at the elevation of the highest peak parallel to the surface plane is 100 μm³ to 2,800 μm³.

The cover window for a display device according to an embodiment comprises a polyamide-based film and a functional layer, wherein the polyamide-based film comprises a polyamide-based polymer, and when the 3D surface roughness of a first side of the polyamide-based film is measured, the volume (natural volume) between the surface and a reference plane placed at the elevation of the highest peak parallel to the surface plane is 100 μm³ to 2,800 μm³.

The process for preparing a polyamide-based film according to an embodiment comprises polymerizing a diamine compound, a dicarbonyl compound, and, optionally, a dianhydride compound in an organic solvent to prepare a solution comprising a polyamide-based polymer; casting the polymer solution onto a belt and drying it to prepare a gel sheet; and thermally treating the gel sheet.

### Advantageous Effects of the Invention

Since the polyamide-based film according to the embodiment comprises a polyamide-based polymer, wherein when the 3D surface roughness of a first side of the film is measured, the volume (natural volume) between the surface and a reference plane placed at the elevation of the highest peak parallel to the surface plane is 100 μm³ to 2,800 μm³, it may be excellent in solvent resistance, improved in optical properties such as yellow index and transmittance, and enhanced in slip properties and windability.

### BRIEF DESCRIPTION OF THE DRAWINGS

FIGS. 1 to 3 are each schematic perspective, exploded, and cross-sectional views of a display device according to an embodiment.

FIG. 4 is a schematic flow diagram of a process for preparing a polyamide-based film according to an embodiment.

FIG. 5 is a schematic drawing that illustrates process facilities for preparing a polyamide-based film according to an embodiment.

### BEST MODE FOR CARRYING OUT THE INVENTION

Hereinafter, the embodiments will be described in detail with reference to the accompanying drawings so that those skilled in the art to which the present invention pertains may easily practice them. However, the embodiments may be implemented in many different ways and are not limited to those described herein.

Throughout the present specification, in the case where each film, window, panel, layer, or the like is mentioned to be formed “on” or “under” another film, window, panel, layer, or the like, it means not only that one element is directly formed on or under another element, but also that one element is indirectly formed on or under another element with other element(s) interposed between them. In addition, the term on or under with respect to each element may be referenced to the drawings. For the sake of description, the sizes of individual elements in the appended drawings may be exaggeratedly depicted and do not indicate the actual sizes. In addition, the same reference numerals refer to the same elements throughout the specification.

Throughout the present specification, when a part is referred to as “comprising” an element, it is understood that other elements may be comprised, rather than other elements are excluded, unless specifically stated otherwise.

In the present specification, a singular expression is interpreted to cover a singular or plural number that is interpreted in context unless otherwise specified.

In addition, all numbers and expressions related to the quantities of components, reaction conditions, and the like used herein are to be understood as being modified by the term “about,” unless otherwise indicated.

The terms first, second, and the like are used herein to describe various elements, and the elements should not be limited by the terms. The terms are used only for the purpose of distinguishing one element from another.

In addition, the term “substituted” as used herein means to be substituted with at least one substituent group selected from the group consisting of deuterium, —F, —Cl, —Br, —I, a hydroxyl group, a cyano group, a nitro group, an amino group, an amidino group, a hydrazine group, a hydrazone group, an ester group, a ketone group, a carboxyl group, a substituted or unsubstituted alkyl group, a substituted or unsubstituted alkenyl group, a substituted or unsubstituted alkynyl group, a substituted or unsubstituted alkoxy group, a substituted or unsubstituted alicyclic organic group, a substituted or unsubstituted heterocyclic group, a substituted or unsubstituted aryl group, and a substituted or unsubstituted heteroaryl group. The substituent groups enumerated above may be connected to each other to form a ring.

Polyamide-Based Film

An embodiment provides a polyamide-based film that is excellent in solvent resistance, improved in optical properties such as yellow index and transmittance, and enhanced in slip properties and windability.

The polyamide-based film according to an embodiment comprises a polyamide-base polymer.

When the 3D surface roughness of a first side of the polyamide-based film is measured, the volume (natural volume) between the surface and a reference plane placed at the elevation of the highest peak parallel to the surface plane is 100 μm³ to 2,800 μm³.

The 3D surface roughness is data obtained by measuring the irregularities of the surface of an object in an optical or contact manner. It may represent the topographical characteristics of a predetermined area relative to the planar direction of the object's surface. The natural volume may refer to, for example, the amount of liquid required on the surface for complete submersion. Specifically, the natural volume may be a value measured by using CONTOUR GT-X of Bruker, setting the measurement area at one time to 166 μm×220 μm, adopting a 20-magnification objective lens for measurement, and then applying a Gaussian filter after the measurement.

For example, if the natural volume of the first side exceeds 2,800 μm³, the change in haze of the film upon being immersed in a solvent becomes very large, resulting in a deterioration in optical properties, and there may be a problem in that defective coating due to bubbles may take place when its surface is coated. If the natural volume of the first side is less than 100 μm³, the windability and slip properties of the film may deteriorate due to blocking when the film is wound.

According to embodiments, if the natural volume of the first side is controlled to 100 μm³ to 2,800 μm³, it is not only excellent in solvent resistance, but also overall improved in optical properties such as transmittance, haze, and yellow index. Further, when the film is wound in the form of a roll, the wound film can be readily unwound without causing defects such as a lump.

Specifically, the natural volume of the first side may be 2,800 μm³ or less, 2,700 μm³ or less, 2,600 μm³ or less, 2,500 μm³ or less, 2,400 μm³ or less, 2,000 μm³ or less, or 1,800 μm³ or less, and 100 μm³ or more, 150 μm³ or more, 200 μm³ or more, or 250 μm³ or more.

More specifically, the natural volume of the first side may be 100 μm³ to 2,500 μm³, 100 μm³ to 2,400 μm³, 250 μm³ to 2,800 μm³, 250 μm³ to 2,500 μm³, or 250 μm³ to 2,400 μm³, but it is not limited thereto.

In an embodiment, the first side may be an air side of the film. The air side refers to a side that does not come into contact with a support used in forming a polyamide-based film. Specifically, in the process for preparing the film, the air side may refer to a side that does not come into contact with a belt on which the polyamide-based polymer solution is cast and dried.

When the 3D surface roughness of a second side of the polyamide-based film is measured, the volume (natural volume) between the surface and a reference plane placed at the elevation of the highest peak parallel to the surface plane may be 5 μm³ to 200 μm³.

Specifically, the natural volume of the second side may be 200 μm³ or less, 180 μm³ or less, 150 μm³ or less, 120 μm³ or less, or 100 μm³ or less, and 5 μm³ or more, 7 μm³ or more, 10 μm³ or more, 12 μm³ or more, or 15 μm³ or more.

More specifically, the natural volume of the second side may be 5 μm³ to 150 μm³, 5 μm³ to 100 μm³, 10 μm³ to 200 μm³, 10 μm³ to 150 μm³, 10 μm³ to 100 μm³, 12 μm³ to 200 μm³, 12 μm³ to 150 μm³, or 12 μm³ to 100 μm³, but it is not limited thereto.

According to embodiments, if the natural volume of the second side is controlled to the above range, the film may be improved in solvent resistance, optical properties, windability, and slip properties.

In an embodiment, the second side may be a belt side of the film. The belt side refers to a side that comes into contact with a support used in forming a polyamide-based film. Specifically, in the process for preparing the film, the belt side may refer to a side that comes into contact with a belt on which the polyamide-based polymer solution is cast and dried.

In some embodiments, when the 3D surface roughness of the polyamide-based film is measured, the number of summits per unit area (Sds) measured by the following measurement method may be 4,400/mm² or less.

[Measurement Method]

CONTOUR GT-X of Bruker is used, the measurement area at one time is set to 166 μm×220 μm, a 20-magnification objective lens is adopted for measurement, and a Gaussian filter is applied after the measurement.

The summit refers to, for example, a peak appearing at a point higher than the mean plane by 5% or more of the surface elevation difference (Sz) when a 3D surface roughness is measured. In addition, the summit refers to a peak spaced apart from other peaks at a specific distance (1% of the sample side size). The peak may refer to all points located above the nearest eight points. More specifically, the number of summits per unit area (Sds) may be a value measured according to the standard provided in EUR 15178 EN.

Specifically, the Sds may be 4,000/mm² or less, 3,900/mm² or less, 3,800/mm² or less, 3,500/mm² or less, 3,300/mm² or less, or 3,100/mm² or less, but it is not limited thereto. In addition, the Sds may be 500/mm² or more, 800/mm² or more, 1,000/mm² or more, 1,200/mm² or more, 1500/mm² or more, 1,600/mm² or more, 1,800/mm² or more, 2,000/mm² or more, 2,200/mm² or more, or 2,400/mm² or more, but it is not limited thereto.

For example, the Sds may be 1,600 to 4,400/mm², 1,600 to 4,000/mm², 1,600 to 3,900/mm², 1,600 to 3,500/mm², 1,600 to 3,100/mm², 2,000 to 4,400/mm², 2,000 to 4,000/mm², 2,000 to 3,900/mm², 2,000 to 3,500/mm², 2,000 to 3,100/mm², 2,400 to 4,400/mm², 2,400 to 4,000/mm², 2,400 to 3,900/mm², 2,400 to 3,500/mm², or 2,400 to 3,100/mm².

In some embodiments, the surface elevation difference (Sz) may be 320 nm or more. Preferably, the Sz may be 330 nm or more, but it is not limited thereto. In addition, the Sz may be 2,000 nm or less, 1,800 nm or less, 1,500 nm or less, 1,200 nm or less, 1,000 nm or less, 800 nm or less, 700 nm or less, 600 nm or less, or 550 nm or less, but it is not limited thereto.

Sz (surface elevation difference) may refer to an average difference value between the five highest peaks and the five lowest valleys. The peak may refer to all points located above the nearest eight points. The valley may refer to all points located below the nearest eight points. Specifically, Sz may be a ten-point height of surface (S10z) value defined according to ISO 25178. More specifically, Sz may be a value obtained by using CONTOUR GT-X of Bruker, setting the measurement area at one time to 166 μm×220 μm, adopting a 20-magnification objective lens for measurement, and then applying a Gaussian filter after the measurement.

In some embodiments, the summits may have an average curvature (Ssc) of 24 to 47/mm, preferably, 24 to 45/mm, 24 to 42/mm, 25 to 47/mm, 25 to 45/mm, or 25 to 42/mm.

If the film satisfies the above Sds, Sz and/or Ssc characteristics, a film having excellent modulus, transmittance, haze, yellow index, surface hardness, slip properties, and windability may be achieved.

The polyamide-based film according to an embodiment may have an x-direction refractive index (nₓ) of 1.60 to 1.70, 1.61 to 1.69, 1.62 to 1.68, 1.64 to 1.68, 1.64 to 1.66, or 1.64 to 1.65.

In addition, the polyamide-based film may have a y-direction refractive index (n_{y}) of 1.60 to 1.70, 1.61 to 1.69, 1.62 to 1.68, 1.63 to 1.68, 1.63 to 1.66, or 1.63 to 1.64.

Further, the polyamide-based film may have a z-direction refractive index (n_{z}) of 1.50 to 1.60, 1.51 to 1.59, 1.52 to 1.58, 1.53 to 1.58, 1.54 to 1.58, or 1.54 to 1.56.

If the x-direction refractive index, the y-direction refractive index, and the z-direction refractive index of the polyamide-based film are each within the above ranges, when the film is applied to a display device, its visibility is excellent not only from the front but also from a lateral side, so that a wide angle of view can be achieved.

The polyamide-based film according to an embodiment may have an in-plane retardation (Rₒ) of 800 nm or less. Specifically, the in-plane retardation (Rₒ) of the polyamide-based film may be 700 nm or less, 600 nm or less, 550 nm or less, 100 nm to 800 nm, 200 nm to 800 nm, 200 nm to 700 nm, 300 nm to 700 nm, 300 nm to 600 nm, or 300 nm to 540 nm.

In addition, the polyamide-based film according to an embodiment may have a thickness direction retardation (Rₜₕ) of 5,000 nm or less. Specifically, the thickness direction retardation (Rₜₕ) of the polyamide-based film may be 4,800 nm or less, 4,700 nm or less, 4,650 nm or less, 1,000 nm to 5,000 nm, 1,500 nm to 5,000 nm, 2,000 nm to 5,000 nm, 2,500 nm to 5,000 nm, 3,000 nm to 5,000 nm, 3,500 nm to 5,000 nm, 4,000 nm to 5,000 nm, 3,000 nm to 4,800 nm, 3,000 nm to 4,700 nm, 4,000 nm to 4,700 nm, or 4,200 nm to 4,650 nm.

Here, the in-plane retardation (Rₒ) is a parameter defined by a product (Δn_{xy}×d) of anisotropy (Δn_{xy}=|nₓ−n_{y}|) of refractive indices of two mutually perpendicular axes on a film and the film thickness (d), which is a measure of the degree of optical isotropy and anisotropy.

In addition, the thickness direction retardation (Rₜₕ) is a parameter defined by a product of an average of the two birefringences Δn_{xz}(=|nₓ−n_{z}) and Δn_{yz}(=|n_{y}−n_{z}|) observed on a cross-section in the film thickness direction and the film thickness (d).

If the in-plane retardation and the thickness direction retardation of the polyamide-based film are each within the above ranges, when the film is applied to a display device, it is possible to minimize the optical distortion and color distortion and to minimize the light leakage from a lateral side as well.

The polyamide-based film may comprise a filler.

The filler may adjust such mechanical properties as hardness, modulus, brittleness, and flexibility and such optical properties as transmittance, haze, and yellow index of the film. It may also adjust the topographical characteristics of the film surface.

In some embodiments, particles having a hardness of 2.5 to 6 may be used as the filler without limitation. If the filler has a hardness within the above range, it is possible to enhance the hardness and modulus of the film, while its flexibility may not be deteriorated. In addition, the optical properties of the film may not be impaired. Preferably, the hardness of the filler may be 2.5 to 5 or 2.5 to 4.

Preferably, the filler may comprise at least one selected from the group consisting of silica (SiO₂), barium sulfate (BaSO₄), aluminum oxide (Al₂O₃), and zirconium oxide (ZrO₂).

The filler may have a 50% cumulative mass particle size distribution diameter (D₅₀) of 30 to 250 nm in a particle size distribution. Specifically, the 50% cumulative mass particle size distribution diameter (D₅₀) of the filler may be 30 nm to 200 nm, 30 nm to 180 nm, 30 nm to 150 nm, 30 nm to 120 nm, 30 nm to 100 nm, 40 nm to 200 nm, 40 nm to 180 nm, 40 nm to 150 nm, 40 nm to 120 nm, 40 nm to 100 nm, 50 nm to 200 nm, 50 nm to 180 nm, 50 nm to 150 nm, 50 nm to 120 nm, 50 nm to 100 nm, 60 nm to 200 nm, 60 nm to 180 nm, 60 nm to 150 nm, 60 nm to 120 nm, or 60 nm to 100 nm, but it is not limited thereto.

If the filler has a particle diameter within the above range, the windability and slip properties of the film may be enhanced without deteriorating the flexibility and optical properties of the film.

In some embodiments, the filler may have a 90% cumulative mass particle size distribution diameter (D₉₀) of 50 to 1,000 nm in a particle size distribution. Specifically, the 90% cumulative mass particle size distribution diameter (D₉₀) of the filler may be 50 nm to 900 nm, 50 nm to 800 nm, 50 nm to 700 nm, 50 nm to 600 nm, 50 nm to 500 nm, 70 nm to 1,000 nm, 70 nm to 900 nm, 70 nm to 800 nm, 70 nm to 700 nm, 70 nm to 600 nm, 70 nm to 500 nm, 90 nm to 1,000 nm, 90 nm to 900 nm, 90 nm to 800 nm, 90 nm to 700 nm, 90 nm to 600 nm, 90 nm to 500 nm, 110 nm to 1,000 nm, 110 nm to 900 nm, 110 nm to 800 nm, 110 nm to 700 nm, 110 nm to 600 nm, or 110 nm to 500 nm, but it is not limited thereto.

In some embodiments, the filler may have a 10% cumulative mass particle size distribution diameter (D₁₀) of 5 to 200 nm in a particle size distribution. Specifically, the 10% cumulative mass particle size distribution diameter (D₁₀) of the filler may be 5 nm to 180 nm, 5 nm to 160 nm, 5 nm to 140 nm, 5 nm to 130 nm, 10 nm to 200 nm, 10 nm to 180 nm, 10 nm to 160 nm, 10 nm to 140 nm, 10 nm to 130 nm, 15 nm to 200 nm, 15 nm to 180 nm, 15 nm to 160 nm, 15 nm to 140 nm, 15 nm to 130 nm, 20 nm to 200 nm, 20 nm to 180 nm, 20 nm to 160 nm, 20 nm to 140 nm, or 20 nm to 130 nm, but it is not limited thereto.

The filler employed in the polyamide-based film may have a SPAN value of 0.5 to 20 as defined in the following Equation 1.

$$S P A N = \frac{{D}_{90} - {D}_{10}}{{D}_{50}} \qquad [ Equation 1 ]$$

In Equation 1, D₁₀ is the 10% cumulative mass particle size distribution diameter in a particle size distribution of the filler, D₅₀ is the 50% cumulative mass particle size distribution diameter in a particle size distribution of the filler, and D₉₀ is the 90% cumulative mass particle size distribution diameter in a particle size distribution of the filler.

Specifically, the SPAN value may be 0.5 to 10, 0.5 to 5, 0.5 to 2, 0.7 to 20, 0.7 to 10, 0.7 to 5, 0.7 to 2, 0.8 to 20, 0.8 to 10, 0.8 to 5, 0.8 to 2, 0.9 to 20, 0.9 to 10, 0.9 to 5, or 0.9 to 2, but it is not limited thereto.

The content of the filler may be 200 ppm or more based on the total weight of the polyamide-based polymer. Specifically, the content of the filler may be 400 ppm or more, 600 ppm or more, 800 ppm or more, 1,000 ppm or more, or 1,500 ppm or more, based on the total weight of the polyamide-based polymer. In addition, it may be 2,500 ppm or less, 2,300 ppm or less, 2,100 ppm or less, 2,000 ppm or less, or 1,500 ppm or less, based on the total weight of the polyamide-based polymer, but it is not limited thereto. More specifically, the content of the filler may be 200 to 2,500 ppm based on the total weight of the polyamide-based polymer, but it is not limited thereto.

If the content of the filler is outside the above range, the haze of the film is steeply increased, and the filler may aggregate with each other on the surface of the film, so that a feeling of foreign matter may be visually observed, or it may cause a trouble in the sliding performance or deteriorate the windability in the preparation process. In addition, such mechanical properties as hardness and flexibility and such optical properties as transmittance and yellow index of the film may be overall impaired.

For example, the surface characteristics such as natural volume, Sds, Sz, and Ssc expressed as the 3D surface roughness can be adjusted to desired ranges by controlling the particle size and content of the filler.

The filler may have a refractive index of 1.55 to 1.75. Specifically, the refractive index of the filler may be 1.60 to 1.75, 1.60 to 1.70, 1.60 to 1.68, or 1.62 to 1.65, but it is not limited thereto.

If the refractive index of the filler satisfies the above range, the birefringence values related to nₓ, n_{y}, and n_{z} can be appropriately adjusted, and the luminance of the film at various angles can be improved.

On the other hand, if the refractive index of the filler is outside the above range, there may arise a problem in that the filler is visually noticeable on the film or that the haze is increased due to the filler.

The surface of the filler is not subjected to special coating treatment, and it may be uniformly dispersed in the entire film.

As the polyamide-based film comprises the filler, the film can secure a wide angle of view without a deterioration in the optical properties.

The content of residual solvents in the polyamide-based film may be 1,500 ppm or less. For example, the content of residual solvents may be 1,200 ppm or less, 1,000 ppm or less, 800 ppm or less, or 500 ppm or less, but it is not limited thereto.

The residual solvent refers to a solvent that has not been volatilized during the film production and remains in the film finally produced.

If the content of the residual solvents in the polyamide-based film exceeds the above range, the durability of the film may be deteriorated, and it may have an impact on the luminance.

When the polyamide-based film according to an embodiment based on a thickness of 50 μm is folded to have a radius of curvature of 3 mm, the number of folding before the fracture may be 200,000 or more.

The number of folding counts one when the film is folded to have a radius of curvature of 3 mm and then unfolded.

As the number of folding of the polyamide-based film satisfies the above range, it can be advantageously applied to a foldable display device or a flexible display device.

The polyamide-based film according to an embodiment may have a surface roughness of 0.01 μm to 0.07 μm. Specifically, the surface roughness may be 0.01 μm to 0.07 μm or 0.01 μm to 0.06 μm, but it is not limited thereto.

As the surface roughness of the polyamide-based film satisfies the above range, it may be advantageous for achieving high luminance even when the angle from the normal direction of a surface light source is increased.

In some embodiments, the polyamide-based film may have a thickness deviation of 4 μm or less based on a thickness of 50 μm. The thickness deviation may refer to a deviation between the maximum or minimum value with respect to the average of thicknesses measured at 10 random points of the film. In such a case, as the polyamide-based film has a uniform thickness, its optical properties and mechanical properties at each point may be uniformly exhibited.

The polyamide-based film may have a transmittance of 80% or more. For example, the transmittance may be 82% or more, 85% or more, 88% or more, 89% or more, 80% to 99%, 88% to 99%, or 89% to 99%, but it is not limited thereto.

The polyamide-based film may have a yellow index of 4 or less. For example, the yellow index may be 3.5 or less, or 3 or less, but it is not limited thereto.

The polyamide-based film may have a modulus of 5 GPa or more. Specifically, the modulus may be 5.5 GPa or more, 6.0 GPa or more, or 6.5 GPa or more, but it is not limited thereto.

The polyamide-based film may have a compressive strength of 0.4 kgf/μm or more. Specifically, the compressive strength may be 0.45 kgf/μm or more, or 0.46 kgf/μm or more, but it is not limited thereto.

When the polyamide-based film is perforated at a speed of 10 mm/minute using a 2.5-mm spherical tip in a UTM compression mode, the maximum diameter (mm) of perforation including a crack is 60 mm or less. Specifically, the maximum diameter of perforation may be 5 mm to 60 mm, 10 mm to 60 mm, 15 mm to 60 mm, 20 mm to 60 mm, 25 mm to 60 mm, or 25 mm to 58 mm, but it is not limited thereto.

The polyamide-based film may have a haze of 1% or less. Specifically, the haze may be 0.7% or less, or 0.5% or less, but it is not limited thereto.

The polyamide-based film may have a surface hardness of HB or higher. Specifically, the surface hardness may be H or higher, but it is not limited thereto.

The polyamide-based film may have a tensile strength of 15 kgf/mm² or more. Specifically, the tensile strength may be 18 kgf/mm² or more, 20 kgf/mm² or more, 21 kgf/mm² or more, or 22 kgf/mm² or more, but it is not limited thereto.

The polyamide-based film may have an elongation of 15% or more. Specifically, the elongation may be 16% or more, 17% or more, or 17.5% or more, but it is not limited thereto.

The physical properties of the polyamide-based film as described above are based on a thickness of 40 μm to 60 μm. For example, the physical properties of the polyamide-based film are based on a thickness of 50 μm.

For example, the polyamide-based film comprises a polyamide-based polymer and may have a modulus of 5 GPa or more, a transmittance of 80% or more, a haze of 1% or less, a yellow index of 3 or less, and a pencil hardness of F or higher, based on a film thickness of 50 μm.

When the film is immersed in an MIBK solvent for 5 seconds, dried at 80° C. for 2 minutes, and then measured for haze, the amount of change in haze (ΔHz_{M}) may be 2.0% or less.

Specifically, the amount of change in haze (ΔHz_{M}) of the film after it is immersed in MIBK may be 1.8% or less, 1.6% or less, 1.4% or less, 1.2% or less, or 1.0% or less, but it is not limited thereto.

ΔHz_{M} (%) is a value of Hz_{M}−Hz₀, in which Hz₀ stands for the initial haze (%) of the film, and Hz_{M} stands for the haze (%) measured after the film is immersed in an MIBK solvent for 5 seconds and dried at 80° C. for 2 minutes.

When the film is immersed in an MIBK solvent for 5 seconds and dried at 80° C. for 2 minutes, and the film surface is rubbed 3,000 times with a Minoan wear test eraser having a hardness of 81 (Durometer A Type) under a weight of 500 g, the film surface may have a water contact angle of 60° to 80°.

Specifically, the water contact angle of the film surface may be 65° to 80°. Preferably, the water contact angle of the film surface may be 70° to 80°.

The change in haze (ΔHz_{M}) and the water contact angle of the film surface may be a measure for determining the solvent resistance of a film.

The polyamide-based film according to an embodiment comprises a polyamide-based polymer, which is prepared by polymerizing a diamine compound, a dicarbonyl compound, and, optionally, a dianhydride compound.

For example, the polyamide-based polymer may be prepared by polymerizing a diamine compound and a dicarbonyl compound. It may be prepared by polymerizing a diamine compound, a dicarbonyl compound, and a dianhydride compound.

The polyamide-based polymer is a polymer that comprises an amide repeat unit. In addition, the polyamide-based polymer may optionally further comprise an imide repeat unit.

Specifically, the polyamide-based polymer comprises an amide repeat unit derived from the polymerization of a diamine compound and a dicarbonyl compound; and it, optionally, comprises an imide repeat unit derived from the polymerization of a diamine compound and a dianhydride compound.

The diamine compound is a compound that forms an imide bond with the dianhydride compound and forms an amide bond with the dicarbonyl compound, to thereby form a copolymer.

The diamine compound is not particularly limited, but it may be, for example, an aromatic diamine compound that contains an aromatic structure. For example, the diamine compound may be a compound represented by the following Formula 1.

H₂N-(E)ₑ-NH₂ [Formula 1]

In Formula 1, E may be selected from a substituted or unsubstituted divalent C₆-C₃₀ aliphatic cyclic group, a substituted or unsubstituted divalent C₄-C₃₀ heteroaliphatic cyclic group, a substituted or unsubstituted divalent C₆-C₃₀ aromatic cyclic group, a substituted or unsubstituted divalent C₄-C₃₀ heteroaromatic cyclic group, a substituted or unsubstituted C₁-C₃₀ alkylene group, a substituted or unsubstituted C₂-C₃₀ alkenylene group, a substituted or unsubstituted C₂-C₃₀ alkynylene group, —O—, —S—, —C(═O)—, —CH(OH)—, —S(═O)₂—, —Si(CH₃)₂—, —C(CH₃)₂—, and —C(CF₃)₂—.
e is selected from integers of 1 to 5. When e is 2 or more, the Es may be the same as, or different from, each other.
(E)ₑ in Formula 1 may be selected from the groups represented by the following Formulae 1-1a to 1-14a, but it is not limited thereto.

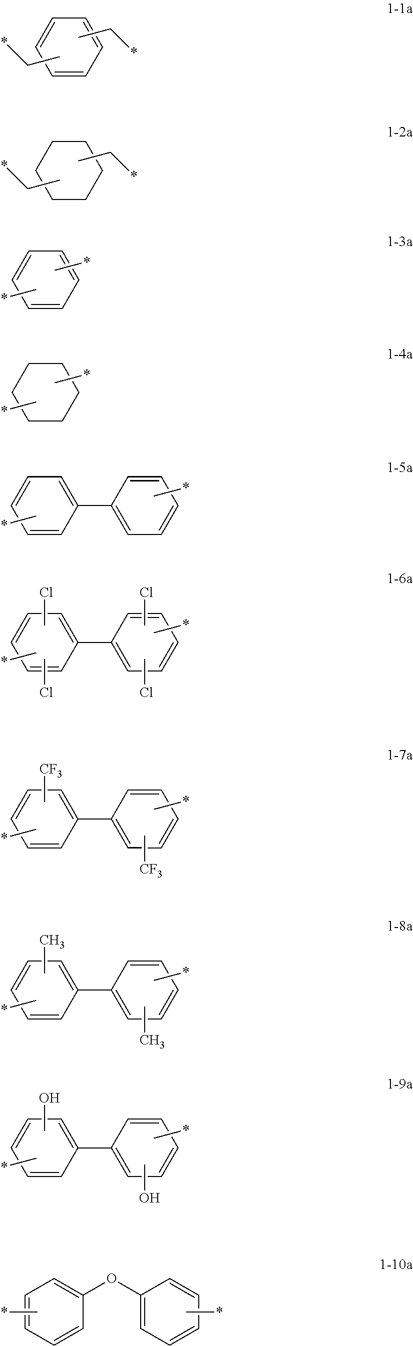

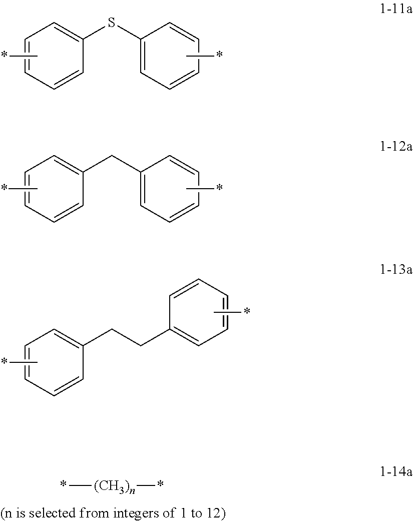

Specifically, (E)ₑ in Formula 1 may be selected from the groups represented by the following Formulae 1-1 b to 1-13b, but it is not limited thereto.

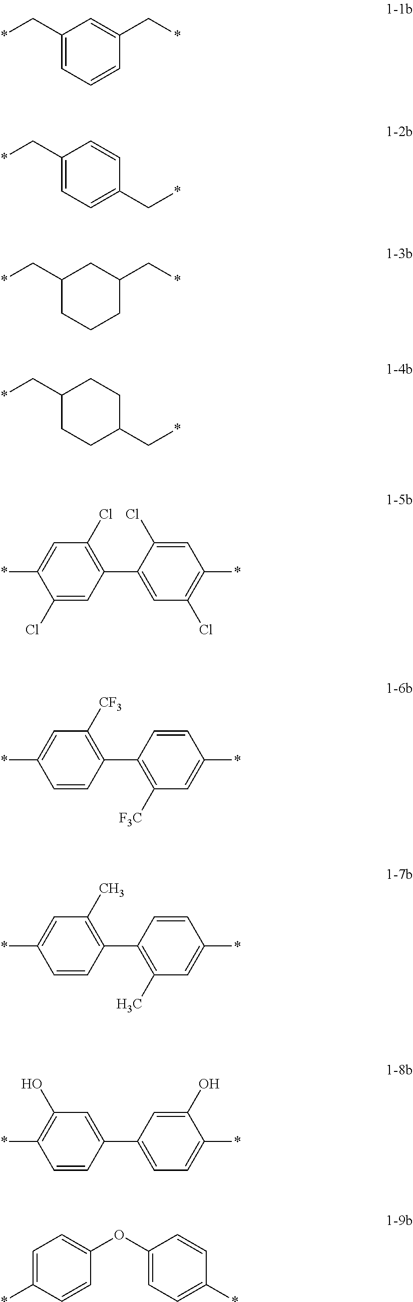

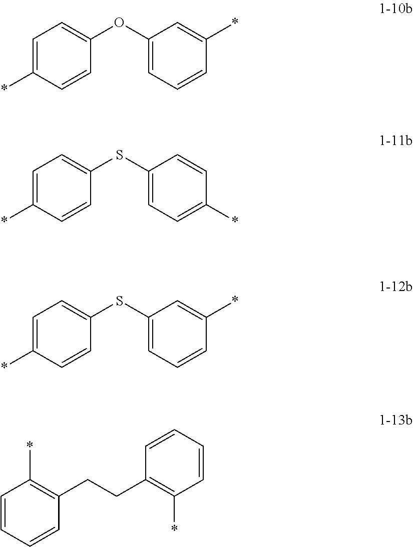 [SMILES: *c1ccc(Oc2cccc(*)c2)cc1 ; *c1ccc(Sc2ccc(*)cc2)cc1 ; *c1ccc(Sc2cccc(*)c2)cc1 ; *c1ccccc1CCc1ccccc1*]

More specifically, (E)e in Formula 1 may be the group represented by the above Formula 1-6b or the group represented by the above Formula 1-9b.

In an embodiment, the diamine compound may comprise a compound having a fluorine-containing substituent or a compound having an ether group (—O—).

The diamine compound may be composed of a compound having a fluorine-containing substituent. In such an event, the fluorine-containing substituent may be a fluorinated hydrocarbon group and specifically may be a trifluoromethyl group. But it is not limited thereto.

In some embodiments, the diamine compound may comprise one kind of diamine compound. That is, the diamine compound may be composed of a single component.

For example, the diamine compound may comprise 2,2′-bis(trifluoromethyl)-4,4′-diaminobiphenyl (TFDB/TFDB) represented by the following formula, but it is not limited thereto.

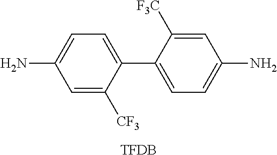

The dianhydride compound has a low birefringence value, so that it can contribute to enhancements in the optical properties such as the transmittance of a film that comprises the polyamide-based polymer.

The dianhydride compound is not particularly limited, but it may be, for example, an aromatic dianhydride compound that contains an aromatic structure. For example, the aromatic dianhydride compound may be a compound represented by the following Formula 2.

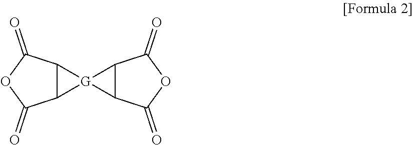

In Formula 2, G may be a group selected from a substituted or unsubstituted tetravalent C₆-C₃₀ aliphatic cyclic group, a substituted or unsubstituted tetravalent C₄-C₃₀ heteroaliphatic cyclic group, a substituted or unsubstituted tetravalent C₆-C₃₀ aromatic cyclic group, or a substituted or unsubstituted tetravalent C₄-C₃₀ heteroaromatic cyclic group, wherein the aliphatic cyclic group, the heteroaliphatic cyclic group, the aromatic cyclic group, or the heteroaromatic cyclic group may be present alone, may be fused to each other to form a condensed ring, or may be bonded by a bonding group selected from a substituted or unsubstituted C₁-C₃₀ alkylene group, a substituted or unsubstituted C₂-C₃₀ alkenylene group, a substituted or unsubstituted C₂-C₃₀ alkynylene group, —O—, —S—, —C(═O)—, —CH(OH)—, —S(═O)₂—, —Si(CH₃)₂—, —C(CH₃)₂—, and —C(CF₃)₂—.

G in the above Formula 2 may be selected from the groups represented by the following Formulae 2-1a to 2-9a, but it is not limited thereto.

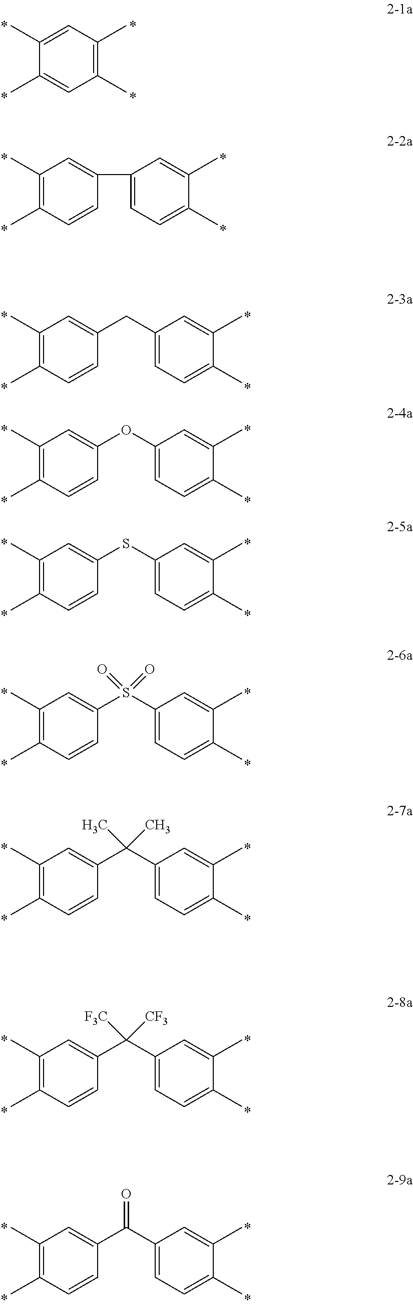

For example, G in Formula 2 may be the group represented by the above Formula 2-2a, the group represented by the above Formula 2-8a, or the group represented by the above Formula 2-9a.

In an embodiment, the dianhydride compound may comprise a compound having a fluorine-containing substituent, a compound having a biphenyl group, or a compound having a ketone group.

The fluorine-containing substituent may be a fluorinated hydrocarbon group and specifically may be a trifluoromethyl group. But it is not limited thereto.

In another embodiment, the dianhydride compound may be composed of a single component or a mixture of two components.

For example, the dianhydride compound may comprise at least one selected from the group consisting of 2,2′-bis-(3,4-dicarboxyphenyl)hexafluoropropane dianhydride (6FDA) and 3,3′,4,4′-biphenyltetracarboxylic dianhydride (BPDA), which have the following structures, but it is not limited thereto.

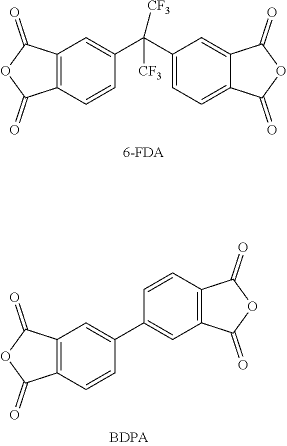 [SMILES: O=C1OC(=O)c2cc(C(c3ccc4c(c3)C(=O)OC4=O)(C(F)(F)F)C(F)(F)F)ccc21 ; O=C1OC(=O)c2cc(-c3ccc4c(c3)C(=O)OC4=O)ccc21]

The diamine compound and the dianhydride compound may be polymerized to form a polyamic acid.

Subsequently, the polyamic acid may be converted to a polyimide through a dehydration reaction, and the polyimide comprises an imide repeat unit.

The polyimide may form a repeat unit represented by the following Formula A.

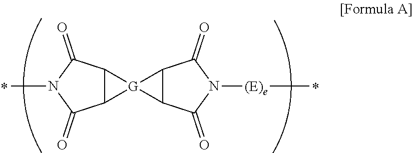

In Formula A, E, G, and e are as described above.

For example, the polyimide may comprise a repeat unit represented by the following Formula A-1, but it is not limited thereto.

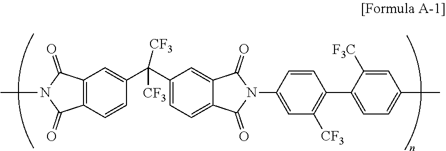

In Formula A-1, n is an integer of 1 to 400.

The dicarbonyl compound is not particularly limited, but it may be, for example, a compound represented by the following Formula 3.

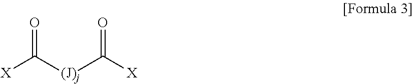

In Formula 3, J may be selected from a substituted or unsubstituted divalent C₆-C₃₀ aliphatic cyclic group, a substituted or unsubstituted divalent C₄-C₃₀ heteroaliphatic cyclic group, a substituted or unsubstituted divalent C₆-C₃₀ aromatic cyclic group, a substituted or unsubstituted divalent C₄-C₃₀ heteroaromatic cyclic group, a substituted or unsubstituted C₁-C₃₀ alkylene group, a substituted or unsubstituted C₂-C₃₀ alkenylene group, a substituted or unsubstituted C₂-C₃₀ alkynylene group, —O—, —S—, —C(═O)—, —CH(OH)—, —S(═O)₂—, —Si(CH₃)₂—, —C(CH₃)₂—, and —C(CF₃)₂—.
j is selected from integers of 1 to 5. When j is 2 or more, the Js may be the same as, or different from, each other.
X is a halogen atom. Specifically, X may be F, Cl, Br, I, or the like. More specifically, X may be Cl, but it is not limited thereto.
(J)ⱼ in the above Formula 3 may be selected from the groups represented by the following Formulae 3-1a to 3-14a, but it is not limited thereto.

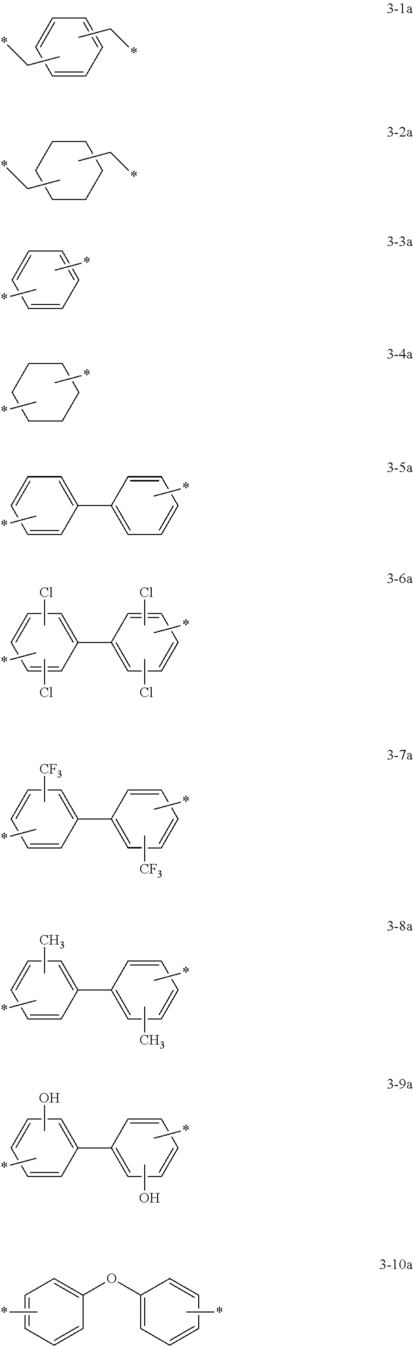

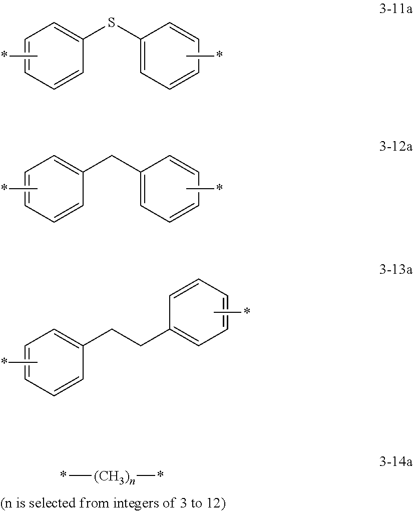

Specifically, (J)ⱼ in the above Formula 3 may be selected from the groups represented by the following Formulae 3-1b to 3-8b, but it is not limited thereto.

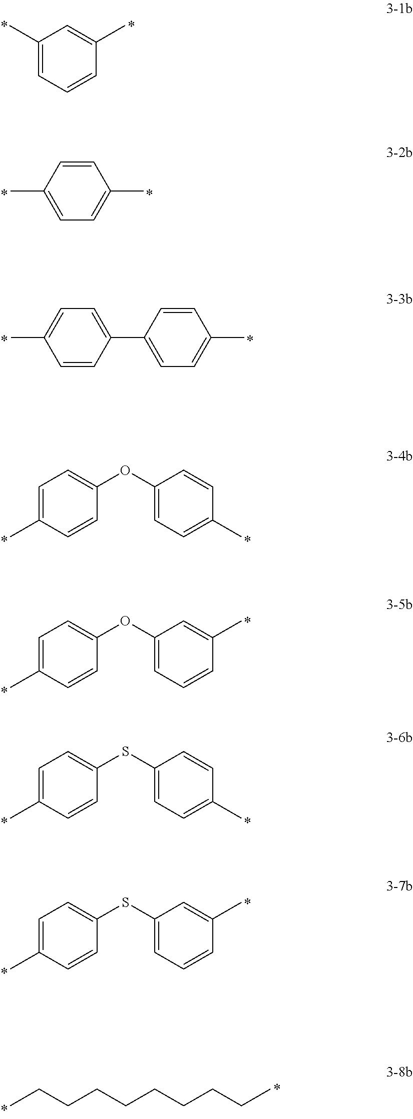

More specifically, (J)ⱼ in Formula 3 may be the group represented by the above Formula 3-1b, the group represented by the above Formula 3-2b, the group represented by the above Formula 3-3b, or the group represented by the above Formula 3-8b.

For example, (J)ⱼ in the above Formula 3 may be the group represented by the above Formula 3-1b or the group represented by the above Formula 3-2b.

In an embodiment, one kind of a dicarbonyl compound may be used alone, or a mixture of at least two kinds of dicarbonyl compounds different from each other may be used, as the dicarbonyl compound. If two or more dicarbonyl compounds are used, at least two dicarbonyl compounds in which (J)ⱼ in the above Formula 3 is selected from the groups represented by the above Formulae 3-1b to 3-8b may be used as the dicarbonyl compound.

In another embodiment, the dicarbonyl compound may be an aromatic dicarbonyl compound that contains an aromatic structure.

The dicarbonyl compound may comprise terephthaloyl chloride (TPC), 1,1′-biphenyl-4,4′-dicarbonyl dichloride (BPDC), isophthaloyl chloride (IPC), as represented by the following formulae, or a combination thereof. But it is not limited thereto.

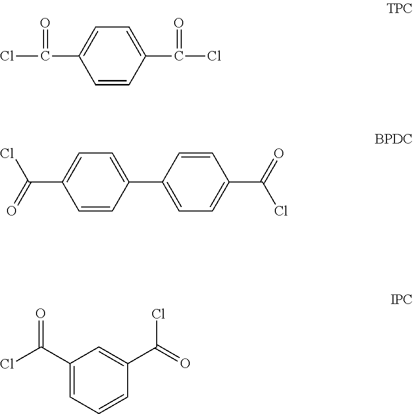 [SMILES: O=C(Cl)c1ccc(C(=O)Cl)cc1 ; O=C(Cl)c1ccc(-c2ccc(C(=O)Cl)cc2)cc1 ; O=C(Cl)c1cccc(C(=O)Cl)c1]

The diamine compound and the dicarbonyl compound may be polymerized to form a repeat unit represented by the following Formula B.

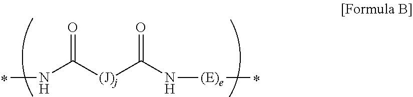

In Formula B, E, J, e, and j are as described above.

For example, the diamine compound and the dicarbonyl compound may be polymerized to form amide repeat units represented by the following Formulae B-1 and B-2.

Alternatively, the diamine compound and the dicarbonyl compound may be polymerized to form amide repeat units represented by the following Formulae B-2 and B-3.

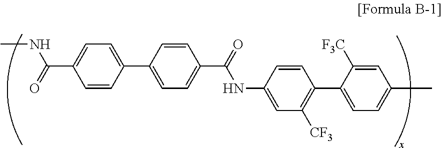

In Formula B-1, x is an integer of 1 to 400.

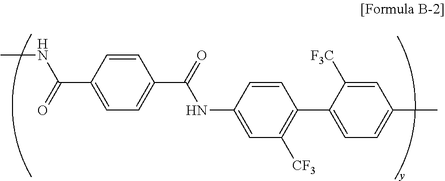

In Formula B-2, y is an integer of 1 to 400.

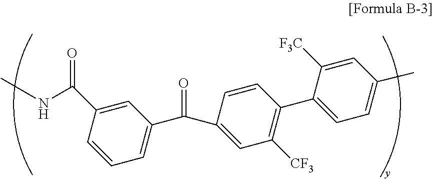

In Formula B-3, y is an integer of 1 to 400.

According to an embodiment, the polyamide-based polymer may comprise a repeat unit represented by the following Formula B; and it may optionally comprise a repeat unit represented by the following Formula A:

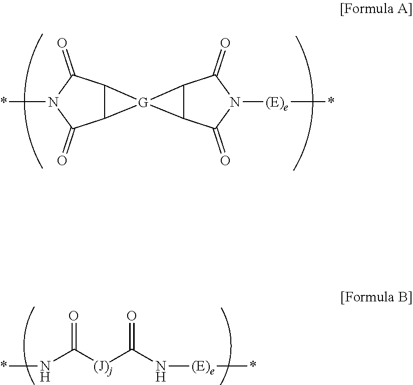

In Formulae A and B, E and J are each independently selected from a substituted or unsubstituted divalent C₆-C₃₀ aliphatic cyclic group, a substituted or unsubstituted divalent C₄-C₃₀ heteroaliphatic cyclic group, a substituted or unsubstituted divalent C₆-C₃₀ aromatic cyclic group, a substituted or unsubstituted divalent C₄-C₃₀ heteroaromatic cyclic group, a substituted or unsubstituted C₁-C₃₀ alkylene group, a substituted or unsubstituted C₂-C₃₀ alkenylene group, a substituted or unsubstituted C₂-C₃₀ alkynylene group, —O—, —S—, —C(═O)—, —CH(OH)—, —S(═O)₂—, —Si(CH₃)₂—, —C(CH₃)₂—, and —C(CF₃)₂—,
e and j are each independently selected from integers of 1 to 5,
when e is 2 or more, then the two or more Es are the same as, or different from, each other,
when j is 2 or more, then the two or more Js are the same as, or different from, each other,
G is a substituted or unsubstituted tetravalent C₆-C₃₀ aliphatic cyclic group, a substituted or unsubstituted tetravalent C₄-C₃₀ heteroaliphatic cyclic group, a substituted or unsubstituted tetravalent C₆-C₃₀ aromatic cyclic group, or a substituted or unsubstituted tetravalent C₄-C₃₀ heteroaromatic cyclic group, wherein the aliphatic cyclic group, the heteroaliphatic cyclic group, the aromatic cyclic group, or the heteroaromatic cyclic group is present alone, fused to each other to form a condensed ring, or bonded by a bonding group selected from a substituted or unsubstituted C₁-C₃₀ alkylene group, a substituted or unsubstituted C₂-C₃₀ alkenylene group, a substituted or unsubstituted C₂-C₃₀ alkynylene group, —O—, —S—, —C(═O)—, —CH(OH)—, —S(═O)₂—, —Si(CH₃)₂—, —C(CH₃)₂—, and —C(CF₃)₂—.

The polyamide-based polymer may comprise an imide-based repeat unit and an amide-based repeat unit at a molar ratio of 0:100 to 80:20. Specifically, the molar ratio of the imide-based repeat unit to the amide-based repeat unit may be 0:100 to 70:30, 0:100 to 60:40, 0:100 to 50:50, 0:100 to 45:55, 1:99 to 50:50, or 5:95 to 50:50, but it is not limited thereto.

If the molar ratio of the imide repeat unit to the amide repeat unit of the polyamide-based polymer is within the above range, it is possible to effectively control to the 3D surface roughness characteristics such as natural volume, Sds, Sz, and Ssc of the polyamide-based film and to enhance the solvent resistance, optical properties, and mechanical durability of the film in combination with the characteristic preparation process.

In the polyamide-based polymer, the molar ratio of the repeat unit represented by the above Formula A to the repeat unit represented by the above Formula B may be 0:100 to 80:20. Specifically, the molar ratio of the repeat unit represented by Formula A to the repeat unit represented by Formula B may be 0:100 to 70:30, 0:100 to 60:40, 0:100 to 50:50, 0:100 to 45:55, 1:99 to 50:50, or 5:95 to 50:50, but it is not limited thereto.

The polyamide-based film according to an embodiment may further comprise at least one selected from the group consisting of a blue pigment, and a UVA absorber in addition to the polyamide-base polymer.

The blue pigment may comprise OP-1300A manufactured by Toyo, but it is not limited thereto.

In some embodiments, the blue pigment may be employed in an amount of 50 to 5,000 ppm based on the total weight of the polyamide-based polymer. Preferably, the blue pigment may be employed in an amount of 100 to 5,000 ppm, 200 to 5,000 ppm, 300 to 5,000 ppm, 400 to 5,000 ppm, 50 to 3,000 ppm, 100 to 3,000 ppm, 200 to 3,000 ppm, 300 to 3,000 ppm, 400 to 3,000 ppm, 50 to 2,000 ppm, 100 to 2,000 ppm, 200 to 2,000 ppm, 300 to 2,000 ppm, 400 to 2,000 ppm, 50 to 1,000 ppm, 100 to 1,000 ppm, 200 to 1,000 ppm, 300 to 1,000 ppm, or 400 to 1,000 ppm, based on the total weight of the polyamide-based polymer, but it is not limited thereto.

The UVA absorber may comprise an absorber that absorbs electromagnetic waves of a wavelength of 10 to 400 nm used in the art. For example, the UVA absorber may comprise a benzotriazole-based compound. The benzotriazole-based compound may comprise an N-phenolic benzotriazole-based compound. In some embodiments, the N-phenolic benzotriazole-based compound may comprise N-phenolic benzotriazole in which the phenol group is substituted with an alkyl group having 1 to 10 carbon atoms. It may be substituted with two or more of the alkyl group, which may be linear, branched, or cyclic.

In some embodiments, the UVA absorber may be employed in an amount of 0.1 to 10% by weight based on the total weight of the polyamide-based polymer. Preferably, the UVA absorber may be employed in an amount of 0.1 to 5% by weight, 0.1 to 3% by weight, 0.1 to 2% by weight, 0.5 to 10% by weight, 0.5 to 5% by weight, 0.5 to 3% by weight, 0.5 to 2% by weight, 1 to 10% by weight, 1 to 5% by weight, 1 to 3% by weight, or 1 to 2% by weight, relative to the total weight of the polyamide-based polymer, but it is not limited thereto.

The physical properties of the polyamide-based film as described above are based on a thickness of 40 μm to 60 μm. For example, the physical properties of the polyamide-based film are based on a thickness of 50 μm.

The features on the components and properties of the polyamide-based film as described above may be combined with each other.

In addition, the 3D surface roughness characteristics such as natural volume, Sds, Sz, and Ssc, the change in haze (ΔHz_{M}), and the solvent resistance such as water contact angle of the film after solvent immersion and rubbing, modulus, transmittance, haze, and yellow index of the polyamide-based film as described above may be adjusted by combinations of the chemical and physical properties of the components, which constitute the polyamide-based film, along with the specific conditions in each step of the process for preparing the polyamide-based film as described below.

For example, the composition and content of the components that constitute the polyamide-based film, the particle size and content of the filler, polymerization conditions, thermal treatment conditions, and solvent evaporation per unit area in the film preparation process, and the like are all combined to achieve the natural volume, Sds, Sz, Ssc, ΔHz_{M}, and water contact angle of the film in the desired ranges.

Cover Window for a Display Device

The cover window for a display device according to an embodiment comprises a polyamide-based film and a functional layer.

When the 3D surface roughness of a first side of the polyamide-based film is measured, the volume (natural volume) between the surface and a reference plane placed at the elevation of the highest peak parallel to the surface plane is 100 μm³ to 2,800 μm³.

Details on the Polyamide-Based Film are as Described Above.

The cover window for a display device can be advantageously applied to a display device.

As the polyamide-based film has the 3D surface roughness characteristics as described above, it may have excellent solvent resistance, optical properties, and slip properties/windability.

Display Device

The display device according to an embodiment comprises a display unit; and a cover window disposed on the display unit, wherein the cover window comprises a polyamide-based film and a functional layer.

When the 3D surface roughness of a first side of the polyamide-based film is measured, the volume (natural volume) between the surface and a reference plane placed at the elevation of the highest peak parallel to the surface plane is 100 μm³ to 2,800 μm³.

Details on the Polyamide-Based Film and the Cover Window are as Described Above.

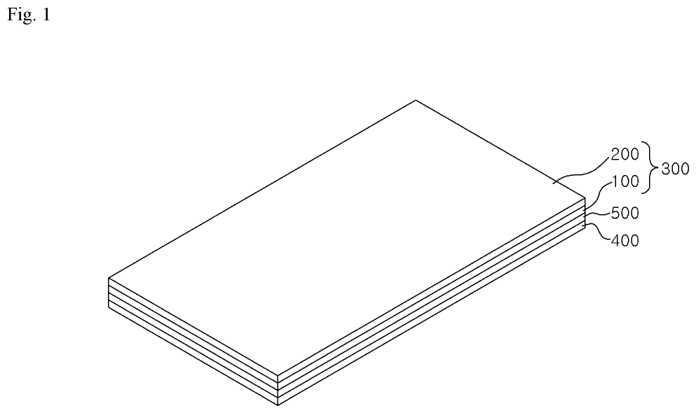

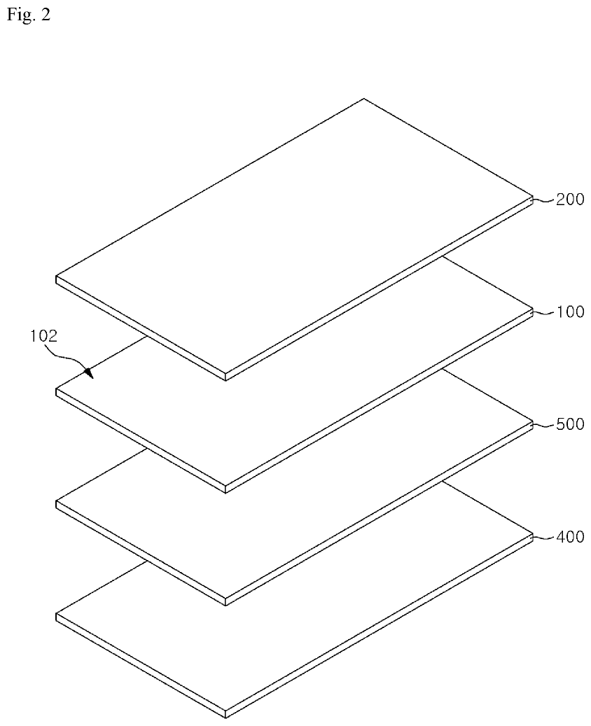

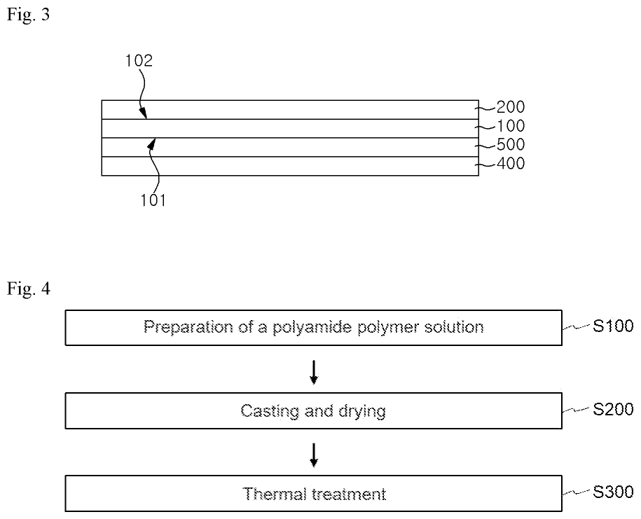

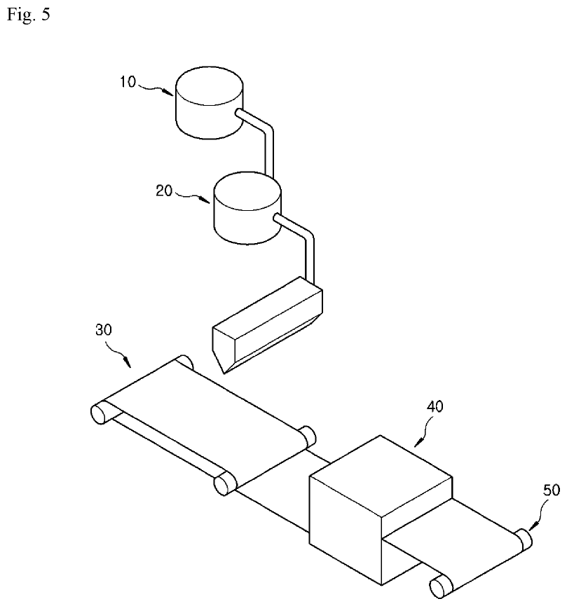

FIGS. 1 to 3 are each schematic exploded, perspective, and cross-sectional views of a display device according to an embodiment.

Specifically, FIGS. 1 to 3 illustrate a display device, which comprises a display unit (400) and a cover window (300) disposed on the display unit (400), wherein the cover window comprises a polyamide-based film (100) having a first side (101) and a second side (102) and a functional layer (200), and an adhesive layer (500) is interposed between the display unit (400) and the cover window (300).

The display unit (400) is for displaying an image, and it may have flexible characteristics.

The display unit (400) may be a display panel for displaying an image. For example, it may be a liquid crystal display panel or an organic electroluminescent display panel. The organic electroluminescent display panel may comprise a front polarizing plate and an organic EL panel.

The front polarizing plate may be disposed on the front side of the organic EL panel. Specifically, the front polarizing plate may be attached to the side on which an image is displayed in the organic EL panel.

The organic EL panel may display an image by self-emission of a pixel unit. The organic EL panel may comprise an organic EL substrate and a driving substrate. The organic EL substrate may comprise a plurality of organic electroluminescent units, each of which corresponds to a pixel. Specifically, it may comprise a cathode, an electron transport layer, a light-emitting layer, a hole transport layer, and an anode. The driving substrate is operatively coupled to the organic EL substrate. That is, the driving substrate may be coupled to the organic EL substrate so as to apply a driving signal such as a driving current, so that the driving substrate can drive the organic EL substrate by applying a current to the respective organic electroluminescent units.

In addition, an adhesive layer (500) may be interposed between the display unit (400) and the cover window (300). The adhesive layer may be an optically transparent adhesive layer, but it is not particularly limited.

The cover window (300) may be disposed on the display unit (400). The cover window is located at the outermost position of the display device according to an embodiment to thereby protect the display unit.

The cover window (300) may comprise a polyamide-based film and a functional layer. The functional layer may be at least one selected from the group consisting of a hard coating, a reflectance reducing layer, an antifouling layer, and an antiglare layer. The functional layer may be coated on at least one side of the polyamide-based film.

The polyamide-based film according to an embodiment can be applied in the form of a film to the outside of a display device without changing the display driving method, the color filter inside the panel, or the laminated structure, thereby providing a display device having a uniform thickness, low haze, high transmittance, and high transparency. Since neither significant process changes nor cost increases are needed, it is advantageous in that the production costs can be reduced.

The polyamide-based film according to an embodiment is excellent in optical properties in terms of high transmittance, low haze, and low yellow index, as well as Sds, Sz, and/or Ssc on 3D surface roughness are adjusted to certain ranges. Thus, it may have excellent mechanical properties such as modulus and pencil hardness and handling conveniences such as slip properties and windability.

In addition, the polyamide-based film according to an embodiment can minimize the optical distortion since it has at most a certain level of in-plane retardation and a thickness direction retardation and can also reduce the light leakage from a lateral side.

The polyamide-based film whose first side has a natural volume in the above range has excellent solvent resistance and optical properties of the film, along with excellent slip properties and windability. Thus, even if the film has a large area, the film can be wound into a roll without damage and then unwound for use, and it can be advantageously applied to a rollable/flexible display device.

Process for Preparing a Polyamide-Based Film

An embodiment provides a process for preparing a polyamide-based film.

The characteristics on 3D surface roughness of the polyamide-based film may be the results materialized by combinations of the chemical and physical properties of the components, which constitute the polyamide-based film, along with the conditions in each step of the process for preparing the polyamide-based film as described below.

For example, the composition and content of the components that constitute the polyamide-based film, the polymerization conditions and thermal treatment conditions in the preparation process of the film, and the like are all combined to achieve the desired characteristics on 3D surface roughness.

The process for preparing a polyamide-based film according to an embodiment comprises polymerizing a diamine compound, a dicarbonyl compound, and, optionally, a dianhydride compound in an organic solvent to prepare a polyamide-based polymer solution (S100); casting the polymer solution onto a belt and then drying it to prepare a gel sheet (S200); and thermally treating the gel sheet (S300) (see FIG. 4).

The process for preparing a polyamide-based film according to some embodiments may further comprise adjusting the viscosity of the polyamide-based polymer solution (S110), aging the polyamide-based polymer solution (S120), and/or degassing the polyamide-based polymer solution (S130).

The polyamide-based film is a film in which a polyamide-based polymer is a main component. The polyamide-based polymer is a resin that comprises an imide repeat unit and an amide repeat unit at a predetermined molar ratio as a structural unit.

In the process for preparing a polyamide-based film, the polymer solution for preparing a polyamide-based polymer may be prepared by simultaneously or sequentially mixing a diamine compound, a dicarbonyl compound, and, optionally, a dianhydride compound in an organic solvent in a reactor, and reacting the mixture (S100).

In an embodiment, the polymer solution may be prepared by simultaneously mixing and reacting a diamine compound and a dicarbonyl compound in an organic solvent.

Specifically, the step of preparing the polymer solution may comprise mixing and reacting a diamine compound and a dicarbonyl compound in a solvent to produce a polyamide solution.

In another embodiment, the polymer solution may be prepared by simultaneously mixing and reacting a diamine compound, a dianhydride compound, and a dicarbonyl compound in an organic solvent.

Specifically, the step of preparing the polymer solution may comprise first mixing and reacting the diamine compound and the dianhydride compound in a solvent to produce a polyamic acid (PAA) solution; and second mixing and reacting the polyamic acid (PAA) solution and the dicarbonyl compound to form an amide bond and an imide bond. The polyamic acid solution is a solution that comprises a polyamic acid.

Alternatively, the step of preparing the polymer solution may comprise first mixing and reacting the diamine compound and the dianhydride compound in a solvent to produce a polyamic acid solution; subjecting the polyamic acid solution to dehydration to produce a polyimide (PI) solution; and second mixing and reacting the polyimide (PI) solution and the dicarbonyl compound to further form an amide bond. The polyimide solution is a solution that comprises a polymer having an imide repeat unit.

In an embodiment, the step of preparing the polymer solution may comprise first mixing and reacting the diamine compound and the dicarbonyl compound in a solvent to produce a polyamide (PA) solution; and second mixing and reacting the polyamide (PA) solution and the dianhydride compound to further form an imide bond. The polyamide solution is a solution that comprises a polymer having an amide repeat unit.

The polymer solution thus prepared may be a solution that comprises a polymer containing at least one selected from the group consisting of a polyamic acid (PAA) repeat unit, a polyamide (PA) repeat unit, and a polyimide (PI) repeat unit.

Alternatively, the polymer contained in the polymer solution comprises an amide repeat unit derived from the polymerization of the diamine compound and the dicarbonyl compound, and it may optionally comprise an imide repeat unit derived from the polymerization of the diamine compound and the dianhydride compound.

Details on the diamine compound, the dianhydride compound, and the dicarbonyl compound are as described above.

In some embodiments, the dianhydride compound and the dicarbonyl compound may be employed at a molar ratio of 0:100 to 80:20. Specifically, the dianhydride compound and the dicarbonyl compound may be employed at a molar ratio of 0:100 to 70:30, 0:100 to 60:40, 0:100 to 50:50, 1:99 to 50:50, or 5:95 to 50:50.

The content of solids contained in the polymer solution may be 10% by weight to 30% by weight. Alternatively, the content of solids contained in the polymer solution may be 15% by weight to 25% by weight or 15% by weight to 20% by weight, but it is not limited thereto.

If the content of solids contained in the polymer solution is within the above range, a polyamide-based film can be effectively produced in the extrusion and casting steps.

In another embodiment, the step of preparing the polymer solution may further comprise introducing a catalyst.

Here, the catalyst may comprise at least one selected from the group consisting of beta picoline, acetic anhydride, isoquinoline (IQ), and pyridine-based compounds, but it is not limited thereto.

The catalyst may be added in an amount of 0.01 to 0.5 molar equivalent, 0.01 to 0.4 molar equivalent, 0.01 to 0.3 molar equivalent, 0.01 to 0.2 molar equivalent, or 0.01 to 0.1 molar equivalent, based on 1 mole of the polyamide-based polymer, but it is not limited thereto.

The further addition of the catalyst may expedite the reaction rate and enhance the chemical bonding force between the repeat unit structures or that within the repeat unit structures.

In an embodiment, the step of preparing the polymer solution may further comprise adjusting the viscosity of the polymer solution (S110). The viscosity of the polymer solution may be 80,000 cps to 500,000 cps, 100,000 cps to 500,000 cps, 150,000 cps to 500,000 cps, 150,000 cps to 450,000 cps, 200,000 cps to 450,000 cps, 200,000 cps to 400,000 cps, 200,000 cps to 350,000 cps, or 200,000 cps to 300,000 cps at room temperature. In such an event, the film-forming capability of a polyamide-based film can be enhanced, thereby enhancing the thickness uniformity.

Specifically, the step of preparing the polymer solution may comprise simultaneously or sequentially mixing and reacting a diamine compound, a dicarbonyl compound, and, optionally, a dianhydride compound in an organic solvent to prepare a first polymer solution; and further adding the dicarbonyl compound to prepare a second polymer solution having the target viscosity.

In the steps of preparing the first polymer solution and the second polymer solution, the polymer solutions have viscosities different from each other. For example, the second polymer solution has a viscosity higher than that of the first polymer solution.

In the steps of preparing the first polymer solution and the second polymer solution, the stirring speeds may be different from each other. For example, the stirring speed when the first polymer solution is prepared may be faster than the stirring speed when the second polymer solution is prepared.

In still another embodiment, the step of preparing the polymer solution may further comprise adjusting the pH of the polymer solution. In this step, the pH of the polymer solution may be adjusted to 4 to 7, for example, 4.5 to 7.

The pH of the polymer solution may be adjusted by adding a pH adjusting agent. The pH adjusting agent is not particularly limited and may include, for example, amine-based compounds such as alkoxyamine, alkylamine, and alkanolamine.

As the pH of the polymer solution is adjusted to the above range, it is possible to prevent the occurrence of defects in a film produced from the polymer solution and to achieve the desired optical properties and mechanical properties in terms of yellow index and modulus.

The pH adjusting agent may be employed in an amount of 0.1% by mole to 10% by mole based on the total number of moles of monomers in the polymer solution.

In an embodiment, the organic solvent may be at least one selected from the group consisting of dimethylformamide (DMF), dimethylacetamide (DMAc), N-methyl-2-pyrrolidone (NMP), m-cresol, tetrahydrofuran (THF), and chloroform. The organic solvent employed in the polymer solution may be dimethylacetamide (DMAc), but it is not limited thereto.

In another embodiment, at least one selected from the group consisting of a filler, a blue pigment, and a UVA absorber may be added to the polymer solution.

Details on the types and contents of the filler, blue pigment, and UVA absorber are as described above. The filler, blue pigment, and/or UVA absorber may be mixed with the polyamide-based polymer in the polymer solution.

The polymer solution may be stored at −20° C. to 20° C., −20° C. to 10° C., −20° C. to 5° C., −20° C. to 0° C., or 0° C. to 10° C.

If it is stored at the above temperature, it is possible to prevent degradation of the polymer solution and to lower the moisture content to thereby prevent defects of a film produced therefrom.

In some embodiments, the polymer solution or the polymer solution whose viscosity has been adjusted may be aged (S120).

The aging may be carried out by leaving the polymer solution at a temperature of −10 to 10° C. for 24 hours or longer. In such an event, the polyamide-based polymer or unreacted materials contained in the polymer solution, for example, may complete the reaction or achieve chemical equilibrium, whereby the polymer solution may be homogenized. The mechanical properties and optical properties of a polyamide-based film formed therefrom may be substantially uniform over the entire area of the film. Preferably, the aging may be carried out at a temperature of −5 to 10° C., −5 to 5° C., or −3 to 5° C., but it is not limited thereto.

In an embodiment, the process may further comprise degassing the polyamide-based polymer solution (S130). The step of degassing may remove moisture in the polymer solution and reduce impurities, thereby increasing the reaction yield and imparting excellent surface appearance and mechanical properties to the film finally produced.

The degassing may comprise vacuum degassing or purging with an inert gas.

The vacuum degassing may be carried out for 30 minutes to 3 hours after depressurizing the internal pressure of the tank in which the polymer solution is contained to 0.1 bar to 0.7 bar. The vacuum degassing under these conditions may reduce bubbles in the polymer solution. As a result, it is possible to prevent surface defects of a film produced therefrom and to achieve excellent optical properties such as haze.

In addition, the purging may be carried out by purging the tank with an inert gas at an internal pressure of 1 atm to 2 atm. The purging under these conditions may remove moisture in the polymer solution, reduce impurities to thereby increase the reaction yield, and achieve excellent optical properties such as haze and mechanical properties.

The inert gas may be at least one selected from the group consisting of nitrogen, helium (He), neon (Ne), argon (Ar), krypton (Kr), xenon (Xe), and radon (Rn), but it is not limited thereto. Specifically, the inert gas may be nitrogen.

The vacuum degassing and the purging with an inert gas may be carried out in separate steps.

For example, the step of vacuum degassing may be carried out, followed by the step of purging with an inert gas, but it is not limited thereto.

The vacuum degassing and/or the purging with an inert gas may improve the physical properties of the surface of a polyamide-based film thus produced.

The polymer solution may be cast to prepare a gel sheet (S200).

For example, the polymer solution may be extruded, coated, and/or dried on a support to form a gel sheet. Specifically, the polymer solution is cast onto a belt and dried to prepare a gel sheet.

In addition, the casting thickness of the polymer solution may be 200 μm to 700 μm. As the polymer solution is cast to a thickness within the above range, the final film produced after the drying and thermal treatment may have an appropriate and uniform thickness.

In some embodiments, the polymer solution may be cast onto a belt and dried at 50° C. to 200° C. In such a case, the evaporation amount of solvents can be effectively adjusted. Preferably, the casting and drying temperature may be 60° C. to 200° C., 70° C. to 200° C., 50° C. to 150° C., 60° C. to 150° C., 70° C. to 150° C., 50° C. to 120° C., 60° C. to 120° C., 70° C. to 120° C., 50° C. to 100° C., 60° C. to 100° C., or 70° C. to 100° C.

In some embodiments, the drying time may be 5 to 60 minutes, 10 to 60 minutes, 15 to 60 minutes, 5 to 50 minutes, 10 to 50 minutes, 15 to 50 minutes, 5 to 40 minutes, 10 to 40 minutes, or 15 to 40 minutes.

In some embodiments, the step of drying the polymer solution to prepare a gel sheet may be carried out by adjusting the evaporation amount of solvents per unit area to 0.5 to 3.0 kg/m². In such a case, the surface roughness characteristics of the film can be effectively adjusted to the desired ranges. Accordingly, a film with enhanced optical properties, mechanical properties, slip properties, and windability can be prepared. Preferably, the evaporation amount of solvents per unit area may be adjusted to 0.5 to 2.5 kg/m², 0.5 to 2.0 kg/m², 0.5 to 1.8 kg/m², 0.5 to 1.6 kg/m², 0.5 to 1.4 kg/m², 0.8 to 3.0 kg/m², 0.8 to 2.5 kg/m², 0.8 to 2.0 kg/m², 0.8 to 1.8 kg/m², 0.8 to 1.6 kg/m², 0.8 to 1.4 kg/m², 1.0 to 3.0 kg/m², 1.0 to 2.5 kg/m², 1.0 to 2.0 kg/m², 1.0 to 1.8 kg/m², 1.0 to 1.6 kg/m², or 1.0 to 1.4 kg/m², but it is not limited thereto.

For example, the moving distance of the belt may be 40 m to 60 m. In addition, the belt may be transferred at a speed of 0.5 m/minute to 15 m/minute, specifically, 1 m/minute to 10 m/minute.

The solvent of the polymer solution may be partially or totally volatilized during the drying to prepare the gel sheet.

According to an embodiment, the content of the residual solvents contained in the gel sheet upon drying may be 1,500 ppm or less. In such a case, the surface roughness characteristics of the film can be effectively adjusted to the desired ranges. Accordingly, a film with enhanced optical properties, mechanical properties, slip properties, and windability can be prepared.

The dried gel sheet may be thermally treated to form a polyamide-based film (S300).

The thermal treatment of the gel sheet may be carried out, for example, through a thermal treatment device (or tenter). The thermal treatment device may comprise at least one hot air blower and at least one heater. The thermal treatment device may comprise any one of at least one hot air blower or at least one heater.

The step of thermally treating the dried gel sheet comprises first thermal treatment through hot air supplied by at least one hot air blower; and second thermal treatment through at least one heater.

The section in which the first thermal treatment step is carried out is referred to as a first thermal treatment section, and the section in which the second thermal treatment step is carried out is referred to as a second thermal treatment section.

The first thermal treatment step and the second thermal treatment step may be sequentially carried out. The second thermal treatment step may be carried out after the first thermal treatment step has been carried out, or the first thermal treatment step may be carried out after the second thermal treatment step has been carried out, but it is not limited thereto. Specifically, the second thermal treatment step may be carried out after the first thermal treatment step has been carried out.

The thermal treatment of the gel sheet may be carried out through a support that continuously moves in the thermal treatment device. Specifically, the gel sheet may be positioned on the support, and the film may move in the longitudinal direction as the support moves in the moving direction.

The step of thermally treating the gel sheet comprises fixing both ends of the gel sheet (film) in the transverse direction with a fixing part; and changing the width of the gel sheet using the fixing part. The step of thermally treating the gel sheet may be carried out by fixing both ends of the gel sheet in the transverse direction with a fixing part, and thermally treating it while the width of the fixed gel sheet is changed. For example, both ends of the film in the transverse direction are fixed with pins in the thermal treatment device, and the width of the gel sheet may be changed as the position of the pins is adjusted while the film is moved by the support.

The step of fixing both ends of the gel sheet in the transverse direction with a fixing part and thermally treating it while the width of the fixed gel sheet is changed may be carried out while the gel sheet passes through the first thermal treatment section and the second thermal treatment section.

In an embodiment, in the step of changing the width of the gel sheet while the gel sheet passes through the first thermal treatment section in the longitudinal direction (in the moving direction) of the gel sheet, the width of the gel sheet may be narrowed.

In addition, in the step of changing the width of the gel sheet while the gel sheet passes through the second thermal treatment section in the longitudinal direction (in the moving direction) of the gel sheet, the width of the gel sheet may be narrowed.

Alternatively, in the step of changing the width of the gel sheet, widening and narrowing the width of the gel sheet may be repeated.

The width of the gel sheet at the inlet of the first thermal treatment section may be greater than the width of the gel sheet at the outlet of the first thermal treatment section, and the width of the gel sheet at the inlet of the second thermal treatment section may be greater than the width of the gel sheet at the outlet of the second thermal treatment section.

In addition, the width of the gel sheet at the inlet of the first thermal treatment section may be greater than the width of the gel sheet at the outlet of the second thermal treatment section, but it is not limited thereto.

The maximum width of the gel sheet in the first thermal treatment section is referred to as Wa, the minimum width of the gel sheet in the first thermal treatment section is referred to as Wb, and the minimum width of the gel sheet in the first thermal treatment section and the second thermal treatment section is referred to as Wc.

For example, the width of the gel sheet at the inlet of the first thermal treatment section may be the maximum width of the gel sheet in the first thermal treatment section (Wa), and the width of the gel sheet at the outlet of the first thermal treatment section may be the minimum width of the gel sheet in the first thermal treatment section (Wb).

In addition, the width of the gel sheet at the inlet of the first thermal treatment section may be greater than the width of the gel sheet at the outlet of the first thermal treatment section, and the width of the gel sheet at the outlet of the second thermal treatment section may be the minimum width of the gel sheet in the first thermal treatment section and the second thermal treatment section (Wc).

As another example, Wb may be greater than or equal to Wc, and Wb may be less than or equal to Wc. Specifically, Wb may be greater than Wc. More specifically, Wa>Wb>Wc, but it is not limited thereto.

In an embodiment, the Wb/Wa value is 0.955 to 0.990. For example, the Wb/Wa value may be 0.955 or more, 0.960 or more, 0.965 or more, 0.968 or more, or 0.969 or more, and may be 0.990 or less, 0.985 or less, 0.980 or less, or 0.975 or less, but it is not limited thereto. As another example, it may be 0.955 to 0.980.

In addition, the Wc/Wa value is 0.950 to 0.990. For example, the Wc/Wa value may be 0.950 or more, 0.953 or more, 0.955 or more, or 0.957 or more, and may be 0.990 or less, 0.985 or less, 0.980 or less, 0.975 or less, 0.970 or less, or 0.965 or less, but it is not limited thereto. As another example, it may be 0.950 to 0.970.

In an embodiment, if the thermal treatment with hot air supplied by the at least one hot air blower is carried out, heat may be uniformly supplied. If heat is not uniformly supplied, a satisfactory surface roughness cannot be achieved, or the surface quality may not be uniform, and the surface energy may be raised or lowered too much.

The thermal treatment with hot air may be carried out in a temperature range of 100° C. to 250° C. for 5 minutes to 100 minutes. Specifically, the thermal treatment of the gel sheet with hot air may be carried out in a temperature range of 100° C. to 250° C. at a temperature elevation rate of 1.5° C./minute to 20° C./minute for 5 minutes to 60 minutes. More specifically, the thermal treatment of the gel sheet may be carried out in a temperature range of 140° C. to 250° C.

In such an event, the initial temperature of the thermal treatment of the gel sheet with hot air may be 100° C. or higher. Specifically, the initial temperature of the thermal treatment of the gel sheet with hot air may be 100° C. to 180° C. In addition, the maximum temperature in the thermal treatment with hot air may be 150° C. to 250° C.

In the thermal treatment with hot air, the temperature stated above is the temperature in the thermal treatment device in which the gel sheet is present. It corresponds to a temperature measured by a temperature sensor located in the first thermal treatment section of the thermal treatment device.

In an embodiment, the step of thermally treating the gel sheet may comprise second thermal treatment through at least one heater, specifically, thermal treatment through a plurality of heaters.

The plurality of heaters may comprise a plurality of heaters spaced apart from each other in the transverse direction (TD direction) of the gel sheet. The plurality of heaters may be mounted on a heater mounting part, and two or more heater mounting parts may be disposed along the moving direction (MD direction) of the gel sheet.

The at least one heater may comprise an IR heater. However, the type of the at least one heater is not limited to the above example and may be variously changed. Specifically, the plurality of heaters may each comprise an IR heater.

The thermal treatment by the at least one heater may be carried out in a temperature range of 250° C. or higher. Specifically, the thermal treatment by the at least one heater may be carried out for 1 minute to 30 minutes or 1 minute to 20 minutes in a temperature range of 250° C. to 400° C.

In the thermal treatment with a heater, the temperature stated above is the temperature in the thermal treatment device in which the gel sheet is present. It corresponds to a temperature measured by a temperature sensor located in the second thermal treatment section of the thermal treatment device.

Subsequently, after the step of thermal treatment of the gel sheet, a step of cooling the cured film may be carried out while it is moved.

The step of cooling the cured film while it is transferred may comprise a first temperature lowering step of lowering the temperature at a rate of 100° C./minute to 1,000° C./minute and a second temperature lowering step of lowering the temperature at a rate of 40° C./minute to 400° C./minute.

In such an event, specifically, the second temperature lowering step is performed after the first temperature lowering step. The temperature lowering rate of the first temperature lowering step may be faster than the temperature lowering rate of the second temperature lowering step.

For example, the maximum rate of the first temperature lowering step is faster than the maximum rate of the second temperature lowering step. Alternatively, the minimum rate of the first temperature lowering step is faster than the minimum rate of the second temperature lowering step.

If the step of cooling the cured film is carried out in such a multistage manner, it is possible to have the physical properties of the cured film further stabilized and to maintain the optical properties and mechanical properties of the film achieved during the curing step more stably for a long period of time.

In addition, a step of winding the cooled cured film using a winder may be carried out.

In such an event, the ratio of the moving speed of the gel sheet on the belt at the time of drying to the moving speed of the cured film at the time of winding is 1:0.95 to 1:1.40. Specifically, the ratio of the moving speeds may be 1:0.99 to 1:1.20, 1:0.99 to 1:1.10, or 1:1.01 to 1:1.10, but it is not limited thereto.

If the ratio of the moving speeds is outside the above range, the mechanical properties of the cured film may be impaired, and the flexibility and elastic properties may be deteriorated.

In the process for preparing a polyamide-based film, the thickness variation (%) according to the following Equation 2 may be 3% to 30%. Specifically, the thickness deviation (%) may be 5% to 20%, but it is not limited thereto.

Thickness variation(%)={(M1−M2)/M1}×100 [Equation 2]

In Equation 2, M1 is the thickness (μm) of the gel sheet, and M2 is the thickness (μm) of the cooled cured film at the time of winding.

The polyamide-based film is prepared by the preparation process as described above such that it is excellent in solvent resistance and in optical and mechanical properties, as well as it is excellent in restoring force when it is bent for a long period of time and the bending force is then released, and wrinkles are not visible after a severe folding test. In addition, as it achieves the desired level of loop stiffness not only at room temperature but also in extremely low-temperature environments, it can be applied to various uses that require flexibility and mechanical durability. For example, the polyamide-based film may be applied to not only display devices but also solar cells, semiconductor devices, sensors, and the like.

Details on the polyamide-based film prepared by the process for preparing a polyamide-based film are as described above.

### EMBODIMENTS FOR CARRYING OUT THE INVENTION

Hereinafter, the above description will be described in detail by referring to examples. However, these examples are set forth to illustrate the present invention, and the scope of the present invention is not limited thereto.

### Example 1

A 1-liter glass reactor equipped with a temperature-controllable double jacket was charged with dimethylacetamide (DMAc) as an organic solvent at 10° C. under a nitrogen atmosphere. Then, 2,2′-bis(trifluoromethyl)-4,4′-diaminobiphenyl (TFMB) as an aromatic diamine was slowly added thereto and dissolved.

Subsequently, the temperature inside the reactor was raised to 30° C. While 2,2′-bis(3,4-dicarboxyphenyl)hexafluoropropane dianhydride (6FDA) was slowly added thereto, the reaction solution was stirred for 2 hours.

The temperature of the reactor was lowered to 10° C., and terephthaloyl chloride (TPC) was slowly added while the mixture was stirred for 1 hour. Then, isophthaloyl chloride (IPC) (94% by mole of the total amount introduced) was added, followed by stirring the mixture for 1 hour, thereby preparing a first polymer solution. The viscosity of the first polymer solution thus prepared was about 1,000 to 10,000 cps.

Then, 1 ml of an IPC solution having a concentration of 10% by weight in a DMAc solvent was added thereto, followed by stirring the mixture for 30 minutes. This procedure was repeated, whereby a second polymer solution having a viscosity of 180,000 to 220,000 cps was prepared.

Here, the viscosity of the polymer solution was measured using RM100 CP2000 PLUS equipment of LAMY Rheology Instruments under a constant temperature condition of 20° C. and a shear rate of 4 s⁻¹ to check whether the target viscosity was reached.

A polymer solution was prepared by adding silica (DMAc-ST-ZL, Nissan) having a particle diameter (average particle diameter D50 according to the BET method) of about 83 nm dispersed in a DMAc solvent to the second polymer solution in an amount of 1,000 ppm based on the total solids content of the polymer solution.

The polymer solution was cast onto a belt and transferred while the injection speed onto the belt, drying temperature, drying time, transferring distance, and transferring speed were adjusted such that about 1.4 kg/m² of DMAc per unit area was evaporated before it was put into a thermosetting device. Here, the drying was carried out in a way that hot air was supplied to the gel sheet.

The dried polyamide-based gel sheet was put into a thermosetting device in which the temperature was raised at a temperature elevation rate of 2° C./minute in the temperature range of 80° C. to 300° C., and it was cooled and wound to obtain a polyamide-based film having a thickness of 50 μm.

The specific composition and molar ratio of the polyamide-based polymer are shown in Table 1 below.

### Examples 2 to 13 and Comparative Examples 1 to 6

Polyamide-based films were each obtained in Examples 2 to 13 and Comparative Examples 1 to 6 in the same manner as in Example 1, except that the composition and molar ratio of monomers of the polyamide-based polymer, the evaporation amount of solvents per unit area in the drying step, and the type, particle size, and content of filler were changed as shown in Table 1 below.

TABLE 1

| | | | | Filler | | | | | | |
|---|---|---|---|---|---|---|---|---|---|---|
| | Polymerization ratio of the | | | | | | | Particle | | |
| | polyamide-based polymer | | | | Particle | Particle | Particle | diameter | | Solvent |
| | Diamine | Dianhydride | Dicarbonyl | | diameter | diameter | diameter | distribution | Total | Evaporation |
| | compound (molar ratio) | compound (molar ratio) | compound (molar ratio) | Type | (D₁₀) (nm) | (D₅₀) (nm) | (D₉₀) (nm) | $\frac{D 90 - D 10}{D 50}$ | content (ppm) | amount (kg/m²) |
| Ex. 1 | TFMB 100 | 6FDA 5 | TPC 70 | SiO₂ | 22 | 83 | 112 | 1.08 | 1,000 | 1.4 |
| | | | IPC 25 | | | | | | | |
| Ex. 2 | TFMB 100 | 6FDA 5 | TPC 70 | SiO₂ | 22 | 83 | 112 | 1.08 | 1,000 | 1 |
| | | | IPC 25 | | | | | | | |
| Ex. 3 | TFMB 100 | 6FDA 10 | TPC 54 | SiO₂ | 22 | 83 | 112 | 1.08 | 1,000 | 1.4 |
| | | BPDA 36 | | | | | | | | |
| Ex. 4 | TFMB 100 | 6FDA 5 | TPC 70 | SiO₂ | 22 | 83 | 112 | 1.08 | 1,500 | 1.4 |
| | | | IPC 25 | | | | | | | |
| Ex. 5 | TFMB 100 | 6FDA 5 | TPC 70 | SiO₂ | 22 | 83 | 112 | 1.08 | 1,500 | 1 |
| | | | IPC 25 | | | | | | | |
| Ex. 6 | TFMB 100 | 6FDA 10 | TPC 54 | SiO₂ | 22 | 83 | 112 | 1.53 | 1,500 | 1.4 |
| | | BPDA 36 | | | | | | | | |
| Ex. 7 | TFMB 100 | 6FDA 5 | TPC 70 | BaSO₄ | 104 | 243 | 476 | 1.53 | 1,000 | 1.4 |
| | | | IPC 25 | | | | | | | |
| Ex. 8 | TFMB 100 | 6FDA 5 | TPC 70 | BaSO₄ | 104 | 243 | 476 | 1.53 | 1,000 | 1 |
| | | | IPC 25 | | | | | | | |
| Ex. 9 | TFMB 100 | 6FDA 10 | TPC 54 | BaSO₄ | 104 | 243 | 476 | 1.53 | 1,000 | 1.4 |
| | | BPDA 36 | | | | | | | | |
| Ex. 10 | TFMB 100 | 6FDA 5 | TPC 70 | BaSO₄ | 126 | 243 | 327 | 0.83 | 1,500 | 1.4 |
| | | | IPC 25 | | | | | | | |
| Ex. 11 | TFMB 100 | 6FDA 10 | TPC 54 | BaSO₄ | 126 | 243 | 327 | 0.83 | 1,500 | 1.6 |
| | | BPDA 36 | | | | | | | | |
| Ex. 12 | TFMB 100 | 6FDA 5 | TPC 70 | BaSO₄ | 126 | 243 | 327 | 0.83 | 2,000 | 1.4 |
| | | | IPC 25 | | | | | | | |
| Ex. 13 | TFMB 100 | 6FDA 10 | TPC 54 | BaSO₄ | 126 | 243 | 327 | 0.83 | 2,000 | 1.4 |
| | | BPDA 36 | | | | | | | | |
| C. Ex. 1 | TFMB 100 | 6FDA 5 | TPC 70 | SiO₂ | 22 | 83 | 3800 | 45.52 | 100 | 1.4 |
| | | | IPC 25 | | | | | | | |
| C. Ex. 2 | TFMB 100 | 6FDA 10 | TPC 54 | SiO₂ | 22 | 83 | 3800 | 45.52 | 100 | 1.4 |
| | | BPDA 36 | | | | | | | | |
| C. Ex. 3 | TFMB 100 | 6FDA 5 | TPC 70 | SiO₂ | 22 | 83 | 3800 | 45.52 | 3,000 | 1.4 |
| | | | IPC 25 | | | | | | | |
| C. Ex. 4 | TFMB 100 | 6FDA 10 | TPC 54 | SiO₂ | 22 | 83 | 3800 | 45.52 | 3,000 | 1.4 |
| | | BPDA 36 | | | | | | | | |
| C. Ex. 5 | TFMB 100 | 6FDA 5 | TPC 70 | BaSO₄ | 104 | 243 | 476 | 1.53 | 1,500 | 3.1 |
| | | | IPC 25 | | | | | | | |
| C. Ex. 6 | TFMB 100 | 6FDA 10 | TPC 54 | BaSO₄ | 104 | 243 | 476 | 1.53 | 1,500 | 3.1 |
| | | BPDA 36 | | | | | | | | |

### Evaluation Example

The films prepared in the Examples and Comparative Examples were each measured and evaluated for the following properties. The results are shown in Table 2 below.

### Evaluation Example 1: Measurement of 3D Surface Roughness

CONTOUR GT-X of Bruker was used for measurement. The measurement area at one time was set to 166 μm×220 μm, a 20-magnification objective lens was adopted for measurement, and a Gaussian filter was then applied for basic calibration. The same measurement was repeated 5 times, and an average value was obtained from the measured data, exclusive of the maximum and minimum values. The volume (natural volume) between the surface and a reference plane placed at the elevation of the highest peak parallel to the surface plane was measured for the air side and belt side of the film, which are shown in Table 2 below. The measurements were carried out according to ISO 25178.

### Evaluation Example 2: Measurement of Transmittance and Haze

The light transmittance and haze were measured using a haze meter NDH-5000W manufactured by Nippon Denshoku Kogyo in accordance with the JIS K 7136 standard.

### Evaluation Example 3: Measurement of the Change in Haze

Each film was immersed in an MIBK solvent for 5 seconds and dried at 80° C. for 2 minutes. The haze was measured again by the method according to Evaluation Example 2, and the change in haze (ΔHz_{M}) was calculated.

### Evaluation Example 4: Measurement of Yellow Index

The yellow index (YI) was measured with a spectrophotometer (UltraScan PRO, Hunter Associates Laboratory) under the conditions of d65 and 10° in accordance with the ASTM-E313 standard.

Evaluation Example 5: Evaluation of Slip Properties

When each film was wound into a roll, the coefficient of static friction between one side and the other side of the film that came into contact with each other was measured and evaluated. It was evaluated as good for 0.3 or less, and it was evaluated as poor for greater than 0.3.

The coefficient of static friction was measured by using a friction coefficient measuring instrument from Qmesys, Korea, in accordance with the measurement standard ASTM D1894 between the first side and the second side of a polyamide-based film sample cut into sizes of 130×250 mm and 63×63 mm, respectively.

### Evaluation Example 6: Evaluation of Windability

Both ends of the film were trimmed to have a width of 1,460 mm, and the film in a length of 500 m was continuously wound to prepare a roll. It was determined by visually observing whether there was a lump showing a difference in light and shade across the entire width. If 2 or more workers out of 10 workers determined that there was a lump, it was evaluated as poor; otherwise, it was evaluated as good.

### Evaluation Example 7: Evaluation of Optical Performance

If the haze of a film measured after immersion in an MIBK solvent according to Evaluation Example 3 was 5% or less, it was evaluated as good. If it was greater than 5%, it was evaluated as poor.

### Evaluation Example 8: Evaluation of Solvent Resistance

Each film was immersed in a solvent of MIBK for 5 seconds and dried at 80° C. for 2 minutes, and the film surface was rubbed 3,000 times with a Minoan wear test eraser having a hardness of 81 (Durometer A Type) under a weight of 500 g. Then, the water contact angle was measured. Here, if the water contact angle was 70 to 80°, it was evaluated as good. If it was outside the range, it was evaluated as poor.

TABLE 2

| | 3D surface roughness | | | | | | | | | Solvent resistance | |
|---|---|---|---|---|---|---|---|---|---|---|---|
| | Natural volume | | | | | | | | | Water contact | |
| | Air side | Belt side | Transmittance | Haze | ΔHz_{M} | Yellow | Slip | | Optical | angle | |
| | (μm³) | (μm³) | (%) | (%) | (%) | index | properties | Windability | performance | (°) | Evaluation |
| Ex. 1 | 350 | 15 | 88.7 | 0.3 | 0.3 | 1.7 | Good | Good | Good | 75 | Good |
| Ex. 2 | 250 | 20 | 88.7 | 0.3 | 0.3 | 1.7 | Good | Good | Good | 72 | Good |
| Ex. 3 | 370 | 12 | 88.7 | 0.3 | 0.3 | 1.7 | Good | Good | Good | 73 | Good |
| Ex. 4 | 1560 | 38 | 88.8 | 0.4 | 0.5 | 1.9 | Good | Good | Good | 74 | Good |
| Ex. 5 | 1240 | 31 | 88.7 | 0.4 | 0.6 | 1.9 | Good | Good | Good | 72 | Good |
| Ex. 6 | 1690 | 35 | 88.2 | 0.4 | 0.5 | 1.9 | Good | Good | Good | 73 | Good |
| Ex. 7 | 420 | 32 | 88.7 | 0.4 | 0.4 | 1.6 | Good | Good | Good | 71 | Good |
| Ex. 8 | 382 | 35 | 88.6 | 0.5 | 0.4 | 1.7 | Good | Good | Good | 70 | Good |
| Ex. 9 | 426 | 40 | 88.5 | 0.4 | 0.4 | 1.6 | Good | Good | Good | 78 | Good |
| Ex. 10 | 2489 | 62 | 88.4 | 0.5 | 0.5 | 1.7 | Good | Good | Good | 78 | Good |
| Ex. 11 | 2705 | 59 | 88.5 | 0.5 | 0.5 | 1.7 | Good | Good | Good | 76 | Good |
| Ex. 12 | 2800 | 91 | 88.2 | 0.7 | 0.8 | 2.1 | Good | Good | Good | 77 | Good |
| Ex. 13 | 2800 | 95 | 88.3 | 0.7 | 0.7 | 2 | Good | Good | Good | 76 | Good |
| C. Ex. 1 | 50 | 5 | 88.9 | 0.2 | 0.2 | 1.9 | Poor | Poor | Good | 74 | Good |
| C. Ex. 2 | 45 | 7 | 88.9 | 0.2 | 0.2 | 1.9 | Poor | Poor | Good | 73 | Good |
| C. Ex. 3 | 4500 | 158 | 87.8 | 10.2 | 48 | 3.8 | Good | Good | Poor | 52 | Poor |
| C. Ex. 4 | 5200 | 172 | 88.1 | 9.2 | 50 | 3.9 | Good | Good | Poor | 46 | Poor |
| C. Ex. 5 | 3200 | 12 | 88.5 | 0.9 | 42 | 1.9 | Good | Good | Poor | 69 | Poor |
| C. Ex. 6 | 2922 | 15 | 88.7 | 0.8 | 45 | 2 | Good | Good | Poor | 67 | Poor |

Referring to Table 2, in the polyamide-based films according to Examples 1 to 13 in which the volume (natural volume) between the surface and a reference plane placed at the elevation of the highest peak parallel to the surface plane when the 3D surface roughness of the first side of the film was measured was controlled to 100 μm³ to 2,800 μm³ had excellent slip properties, windability, optical properties, and solvent resistance, as compared with the polyamide-based films according to Comparative Examples 1 to 6 in which the natural volume was less than 100 μm³ or greater than 2,800 μm³.

Explanation of Reference Numerals

| | |
|---|---|
| 10: polymerization apparatus | 20: tank |
| 30: belt | 40: thermosetting device |
| 50: winder | |
| 100: polyamide-based film | |
| 101: first side | 102: second side |
| 200: functional layer | 300: cover window |
| 400: display unit | 500: adhesive layer |

1. A polyamide-based film, which comprises a polyamide-based polymer, wherein when the 3D surface roughness of a first side of the film is measured, the volume (natural volume) between the surface and a reference plane placed at the elevation of the highest peak parallel to the surface plane is 100 μm³ to 2,800 μm³.

2. The polyamide-based film of claim 1, wherein when the 3D surface roughness of a second side of the film is measured, the volume (natural volume) between the surface and a reference plane placed at the elevation of the highest peak parallel to the surface plane is 10 μm³ to 150 μm³.

3. The polyamide-based film of claim 1, wherein the polyamide-based film comprises a filler,
the filler comprises at least one selected from the group consisting of silica (SiO₂), barium sulfate (BaSO₄), aluminum oxide (Al₂O₃), and zirconium oxide (ZrO₂), and the content of the filler is 200 ppm to 2,500 ppm based on the total weight of the polyamide-based polymer.

4. The polyamide-based film of claim 1, wherein the polyamide-based film comprises a filler, and the filler has a 50% cumulative mass particle size distribution diameter (D₅₀) of 30 to 250 nm in a particle size distribution.

5. The polyamide-based film of claim 1, wherein when the 3D surface roughness of the first side of the film is measured, the volume (natural volume) between the surface and a reference plane placed at the elevation of the highest peak parallel to the surface plane is 250 μm³ to 2,500 μm³, and
when the 3D surface roughness of the second side of the film is measured, the volume (natural volume) between the surface and a reference plane placed at the elevation of the highest peak parallel to the surface plane is 12 μm³ to 100 μm³.

6. The polyamide-based film of claim 1, wherein the polyamide-based film comprises a filler, and the filler employed in the polyamide-based film has a SPAN value of 0.5 to 20 as defined in the following Equation 1:
$$S P A N = \frac{{D}_{90} - {D}_{10}}{{D}_{50}} \qquad [ Equation 1 ]$$
in Equation 1, D₁₀ is the 10% cumulative mass particle size distribution diameter in a particle size distribution of the filler, D₅₀ is the 50% cumulative mass particle size distribution diameter in a particle size distribution of the filler, and D₉₀ is the 90% cumulative mass particle size distribution diameter in a particle size distribution of the filler.

7. The polyamide-based film of claim 1, wherein when the film is immersed in an MIBK solvent for 5 seconds, dried at 80° C. for 2 minutes, and then measured for haze, the amount of change in haze (ΔHz_{M}) is 2.0% or less.

8. The polyamide-based film of claim 1, wherein when the film is immersed in an MIBK solvent for 5 seconds and dried at 80° C. for 2 minutes, and the film surface is rubbed 3,000 times with a Minoan wear test eraser having a hardness of 81 (Durometer A Type) under a weight of 500 g, the film surface has a water contact angle of 70° to 80°.

9. A cover window, which comprises a polyamide-based film and a functional layer, wherein the polyamide-based film comprises a polyamide-based polymer, and when the 3D surface roughness of a first side of the polyamide-based film is measured, the volume (natural volume) between the surface and a reference plane placed at the elevation of the highest peak parallel to the surface plane is 100 μm³ to 2,800 μm³.

10. A process for preparing the polyamide-based film of claim 1, which comprises:
polymerizing a diamine compound, a dicarbonyl compound, and, optionally, a dianhydride compound in an organic solvent to prepare a polyamide-based polymer solution;
casting the polymer solution onto a belt and drying it to prepare a gel sheet; and
thermally treating the gel sheet.

11. The process of claim 10 for preparing the polyamide-based film, wherein the step of drying the polymer solution to prepare a gel sheet is carried out by adjusting the evaporation amount of solvents per unit area to 0.5 to 3.0 kg/m².
